(19) United States
(12) Patent Application Publication
(10) Pub. No.: US 2025/0298488 A1
(43) Pub. Date: Sep. 25, 2025

(54) GENERATING THREE-DIMENSIONAL USER INTERFACES BASED ON TWO-DIMENSIONAL USER INTERFACES

(71) Applicant: Adeia Guides Inc., San Jose, CA (US)

(72) Inventors: Mathew Adams, Matthews, NC (US); Aldis Sipolins, Somerville, MA (US); Dhananjay Lal, Englewood, CO (US); Charles Dasher, Lawrenceville, GA (US)

(21) Appl. No.: 18/612,348

(22) Filed: Mar. 21, 2024

(51) Int. Cl. G06F 3/04815; G06T 15/10; G06T 19/20

(52) U.S. Cl. CPC G06F 3/04815; G06T 15/10; G06T 19/20; G06T 2200/24; G06T 2219/2012; G06T 2219/2016

(57) ABSTRACT

Embodiments herein provide systems and methods for generating three-dimensional (3D) user interfaces (UIs) for extended reality (XR) devices based on two-dimensional (2D) UIs. The system generates 3D UI elements of the 3D UI based on 2D UI elements of the 2D UI and determines a priority for each of the 3D UI elements. The system analyzes the surrounding 3D environment to identify locations of geometric shapes contained within, and the 3D UI elements are mapped to the geometric shapes based on the priority of the 3D UI elements and the location of the geometric shapes. The system generates the 3D UI elements for display on the XR device to create the 3D UI by displaying each 3D UI element over a corresponding geometric shape based on the mapping.

### BACKGROUND

This disclosure is related to systems and methods for generating three-dimensional user interfaces for extended reality devices based on two-dimensional user interfaces.

### SUMMARY

Extended reality (XR) devices provide users with an immersive content-viewing and interactive experience. XR devices may run applications developed for different purposes and display each application's content in a three-dimensional (3D) view. In augmented reality (AR) devices, the content is displayed as an overlay on top of the surrounding physical environment. In virtual reality (VR) devices, the content is displayed to a user in an immersive 3D virtual environment or world. To provide an immersive content-viewing experience, the applications may display their content in a user interface (UI) that provides 3D views based on the surrounding 3D environment, which may be physical or virtual. However, millions of applications exist that were developed for display in a UI that provides a two-dimensional (2D) view.

Such 2D UIs may be displayed on a screen of a device, such as a smartphone, smart television (TV), smartwatch, personal computer, or tablet, to name a few examples. Redesigning every 2D UI to be a 3D UI requires much effort from application developers and a high cost for companies. Data from both UIs must be stored and managed. Maintaining two UIs for a single application may not be realistic and may force companies to choose to develop one UI over the other. Generating or constructing 3D UIs based on existing 2D UIs may overcome some of these challenges. Thus, a system and method are needed to construct 3D UIs that utilize features of the surrounding 3D environment to place elements of the 3D UI based on 2D UIs.

In one approach, XR devices display a 2D UI in a single plane of the surrounding 3D environment. The 2D UI is displayed as a single quadrilateral, as it would be on a smartphone or tablet, which overlays the surrounding 3D environment. While this places a 2D UI in a 3D environment, the displayed quadrilateral obscures the view of a notable portion of the surrounding 3D environment, which may compromise the safety of a user or inconvenience the user. Further, this approach does not consider the spatial limitations and opportunities provided by the surrounding 3D environment. Thus, this approach does not provide a 3D UI that utilizes features of the surrounding 3D environment.

In another approach, elements of a 2D UI may be manually converted into 3D elements. Vector graphic files of the 2D UI elements may be extracted into 3D shapes to create corresponding 3D UI elements. Converting each 2D UI element is a manual process and requires much effort from application developers. While this approach allows for converting 2D UI elements to 3D UI elements, it does not provide a 3D UI with minimal effort from application developers. Further, a 3D UI must be developed to incorporate the newly created 3D elements. While the 3D UI elements may be displayed in the same spatial layout as the 2D UI, this presents the same challenges as displaying a 2D UI in a single plane of the surrounding 3D environment. Thus, this approach does not provide a 3D UI that utilizes features of the surrounding 3D environment.

Accordingly, there is a need to construct a 3D UI having 3D UI elements based on 2D UI elements of a 2D UI, and to create a 3D UI that utilizes features of the surrounding 3D environment when positioning the 3D UI elements. Such a solution leverages properties of the 3D UI elements and characteristics of the surrounding 3D environment.

To solve these problems, systems and methods are provided herein for generating 3D UI elements from 2D UI elements and placing the 3D UI elements based on features of the surrounding 3D environment.

In one approach, a method is provided for generating a 3D UI from a 2D UI. In some embodiments, control circuitry is used to implement the method. The control circuitry generates 3D UI elements of the 3D UI based on 2D UI elements of the 2D UI. In some implementations, the control circuitry converts, or automatically converts, the 2D UI elements into the 3D UI elements. In one example, features of the 2D UI elements are extruded into 3D space. In another example, the 2D UI elements are manipulated and oriented in 3D space. In some implementations, the control circuitry maps the 2D UI elements to 3D UI elements of a library of general 3D UI elements.

The control circuitry analyzes the surrounding 3D environment to identify locations of geometric shapes contained within. In some embodiments, the geometric shapes correspond to objects in the surrounding 3D environment. In some implementations, each geometric shape is a plane formed by a surface(s) of the objects. In some implementations, the control circuitry uses sensors to analyze the environment. In other implementations, the control circuitry uses existing data. The control circuitry determines a priority for each of the 3D UI elements and maps the 3D UI elements to the geometric shapes based on the priority of the 3D UI elements and the location of the geometric shapes. The priority is used to display higher-priority 3D UI elements in geometric shapes having a size and/or position that is more prominent in the surrounding 3D environment. In some embodiments, the priority of the 3D UI elements is determined based on a historical frequency of interaction with each 3D UI element. In some embodiments, the priority is based on spatial relationships of corresponding 2D UI elements in the 2D UI. In some embodiments, the priority is based on a result that occurs after receiving the user input indicating an interaction with a 3D UI element.

The control circuitry generates the 3D UI elements for display on an XR device to create a 3D UI. Each 3D UI element is displayed over a corresponding geometric shape based on the mapping. In some embodiments, the mapping further includes adjusting the orientation of the 3D UI elements to match the orientation of the corresponding geometric shapes.

Such an approach overcomes the challenges of converting 2D UIs into 3D Uis by either automatically mapping 2D UI elements to 3D UI elements or generating 3D UI elements using the 2D UI elements with minimal to no manual effort. Automatic conversion removes a large hurdle for software developers to enter the 3D UI market. The challenges of developing a 3D UI with minimal effort from application developers are overcome by mapping the 3D UI elements to the geometric shapes based on priority and location. The challenges of creating a 3D UI that does not obstruct the surrounding 3D environment are overcome by displaying the 3D UI elements over the geometric shapes in the surrounding 3D environment. Automatically mapping the display location of the 3D UI elements allows the 3D UI to adapt to a surrounding 3D environment. Further, this approach can be repeated for each 2D UI upon each instance of use, which may reduce the storage and effort required to maintain two versions of the same UI. These aspects, in combination, provide a system and method that generates 3D UIs that utilize features of the surrounding 3D environment to place elements of the 3D UI based on 2D UIs.

In some embodiments, the control circuitry may receive a user input indicating an interaction with a 3D UI element. In response to such an interaction, the control circuitry modifies the 3D UI and/or calls a function. In some embodiments, the functionality of the 3D UI elements is based on the functionality of the corresponding 2D UI elements.

In another approach, the control circuitry determines an object type for objects in the surrounding 3D environment. In some implementations, the objects include items that do not have a corresponding geometric shape. The control circuitry determines a distance from each object to the geometric shapes and maps the 3D UI elements to the geometric shapes based on the object type and the distance. In some implementations, the mapping is based on objects that are within a proximity threshold of each geometric shape. In one example, mapping is based on the object type of the objects within the proximity threshold. In some embodiments, the control circuitry maps the 3D UI elements to the geometric shapes based on the functionality of the 3D UI elements. In one implementation of this approach, the control circuitry uses the mapping to contextually place the 3D UI elements near objects based on the functionality of the 3D UI element. Such an approach overcomes the challenges of designing a 3D UI that is easy to use by displaying the 3D UI elements in contextually relevant locations of the surrounding 3D environment.

In another approach, the control circuitry saves the location of the geometric shapes and the mapping to a non-transitory memory. Such an approach allows the XR device to leave the surrounding 3D environment or to be powered down. Upon returning to the surrounding 3D environment or powering up, the control circuitry re-generates for display the 3D UI elements over their respective geometric shapes without having to redo the mapping, which saves computational resources and decreases load times. Such an approach overcomes the challenges of providing a 3D UI with limited computational resources, limited power requirements, and short loading times by reusing existing mappings.

In another approach, the control circuitry determines the surrounding 3D environment has changed. The control circuitry identifies the geometric shapes in the new surrounding 3D environment, maps the 3D UI elements to the new geometric shapes, and generates for display the 3D UI elements over the new geometric shapes. In some embodiments, mappings for different surrounding 3D environments are saved to a non-transitory memory and used to re-generate for display the 3D UI. Such an approach overcomes the challenges of providing a 3D UI that utilizes features of the surrounding 3D environment by mapping the 3D UI to each surrounding 3D environment.

Using the methods described herein, a 3D UI may be generated based on a 2D UI with minimal effort from application developers. Elements of the 3D UI are mapped to features of the surrounding 3D environment to provide an adaptable and immersive content-viewing experience.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A and 1B are schematic illustrations of a process for using a system to generate a 3D UI based on a 2D UI, in accordance with embodiments of the disclosure;

FIG. 2 is a flowchart of a detailed illustrative process for generating a 3D UI based on a 2D UI, in accordance with embodiments of the disclosure;

FIGS. 3A-3C are schematic illustrations of a process for generating a 3D UI based on a 2D UI, in accordance with embodiments of the disclosure;

FIG. 4 is a flow chart of a detailed illustrative process for modifying a 2D UI and corresponding 3D UI, in accordance with embodiments of the disclosure;

FIG. 5 is a flowchart of a detailed illustrative process for updating a 3D UI based on the surrounding physical environment, in accordance with embodiments of the disclosure;

FIG. 6 is a schematic illustration of a process for using a system to contextually map 3D UI elements to a surrounding physical environment, in accordance with embodiments of the disclosure;

FIG. 7 is an illustrative example of mapping 3D UI elements of a 3D UI to a virtual object, in accordance with embodiments of the disclosure;

FIG. 8 illustrates an example sequence diagram defining communication to coordinate between a system for generating a 3D UI and a content provider, in accordance with embodiments of the disclosure;

FIG. 9 illustrates an example sequence diagram defining communication to coordinate between a system for caching 3D UI elements and a content provider, in accordance with embodiments of the disclosure;

FIG. 10 depicts example devices and related hardware for generating a 3D UI based on a 2D UI, in accordance with some embodiments of this disclosure;

FIG. 11 depicts example systems, servers, and related hardware for enabling a UI conversion application to carry out the functions described herein, in accordance with some embodiments of this disclosure;

### DETAILED DESCRIPTION

As referred to herein, the phrase “extended reality” refers to an augmented reality or virtual reality device that provides an immersive content-viewing and interactive experience to a user.

As referred to herein, the phrase “augmented reality” refers to any kind of display of an application user interface (UI), or digitally or optically produced content, which overlays a real-world environment. In one example, augmented reality (AR) may be provided using goggles or glasses worn by a user. That is, the goggles may allow the user to partially see the real world, while some digitally produced content is overlaid, by the goggles, over the real-world objects to create a mixed reality. In another example, AR may be provided using a user device, such as a smartphone or tablet, having a display to present live video of the real world to a user or viewer and overlay the digitally produced content. In some embodiments, AR may also refer to a holographic projection of the digitally produced content that overlays real-world objects or is projected in the real world.

As referred to herein, the phrase “virtual reality” refers to any kind of display of an application UI, or digitally or optically produced content, in a three-dimensional (3D) virtual or digital environment, where the 3D virtual environment can be interacted with in a seemingly real or physical way such that a user of a virtual reality (VR) device experiences the 3D virtual environment as if they were there. In some embodiments, VR refers to a combination of the 3D virtual environment and a near-eye display of the VR device. In some embodiments, the VR device provides a visual barrier to obscure a surrounding physical environment from the user's view when presenting the 3D virtual environment to the user.

As referred to herein, the phrase “physical environment” refers to any kind of physical area, where display of digitally produced content may be viewed by one or more users, and physical areas that immediately adjoin such areas. For example, if an application UI, is projected (e.g., on a display of an AR device) in a room, all parts of that room may be considered to be a “physical environment.” In some embodiments, such physical environments may include areas where the application UI is not visible and areas not in a field of view (FOV) of a user or AR device. For example, areas behind or to the side of the projected application UI can still be considered within the “physical environment.”

As referred to herein, the phrase “display” refers to any device(s) or component(s) to display the application user interface (UI). In some embodiments, the application UI is displayed on a display of a head-mounted display (HMD), such as an AR or VR device. The display includes virtual displays and anything capable of generating and displaying an image and/or video from an input to a user of the HMD device. A virtual display is anything that is generated by an XR device, such as an AR device, for displaying an image and/or video from an input. The input may, for example, be a digital content stream wirelessly received at a radio and/or receiver of the XR device. A virtual display may comprise solely the output generated from an application UI, for example, a borderless UI element projected onto the physical world. In another example, a virtual display may comprise one or more virtual elements to make the virtual display appear in a similar manner to a traditional display, such as a TV. The term “physical display” includes the screens of devices such as TVs, computer monitors, tablets, and smartphones, to name a few examples. Other physical displays may include a projector and projection surface or a holographic display.

Users may use an application UI that allows them to efficiently navigate content selections and easily identify content that they may desire to control, view, or listen to, to name a few examples. The application UI may be used by users to manipulate a state of a UI elements. For example, a user may use the application UI to select a movie and to control the playing of the movie. In some embodiments, a 2D application UI is hosted on any of the XR device, a user device, or a server. In some embodiments, a 3D application UI is presented to the user using the XR device.

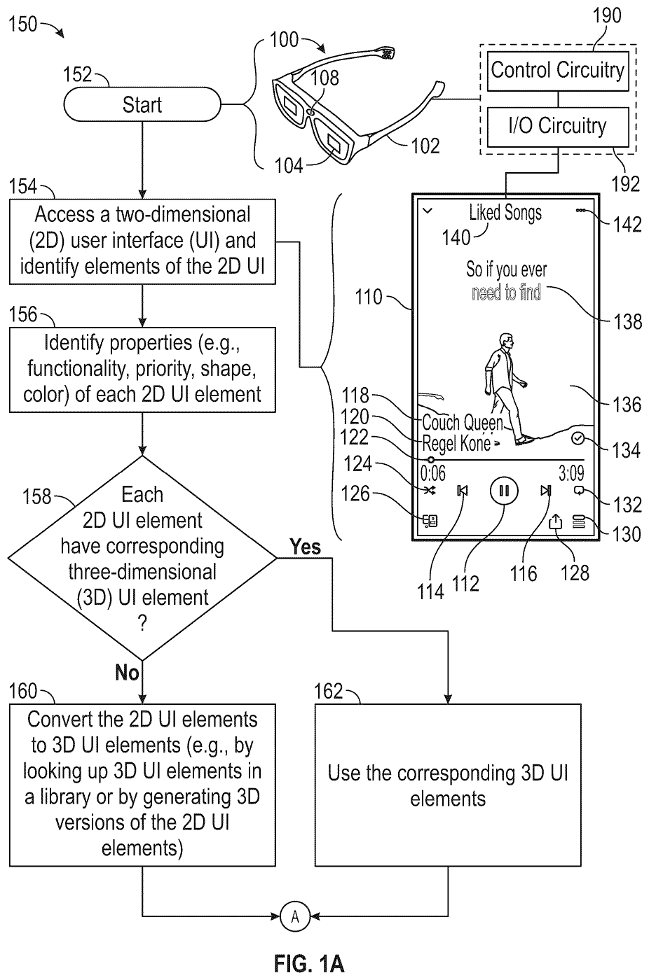

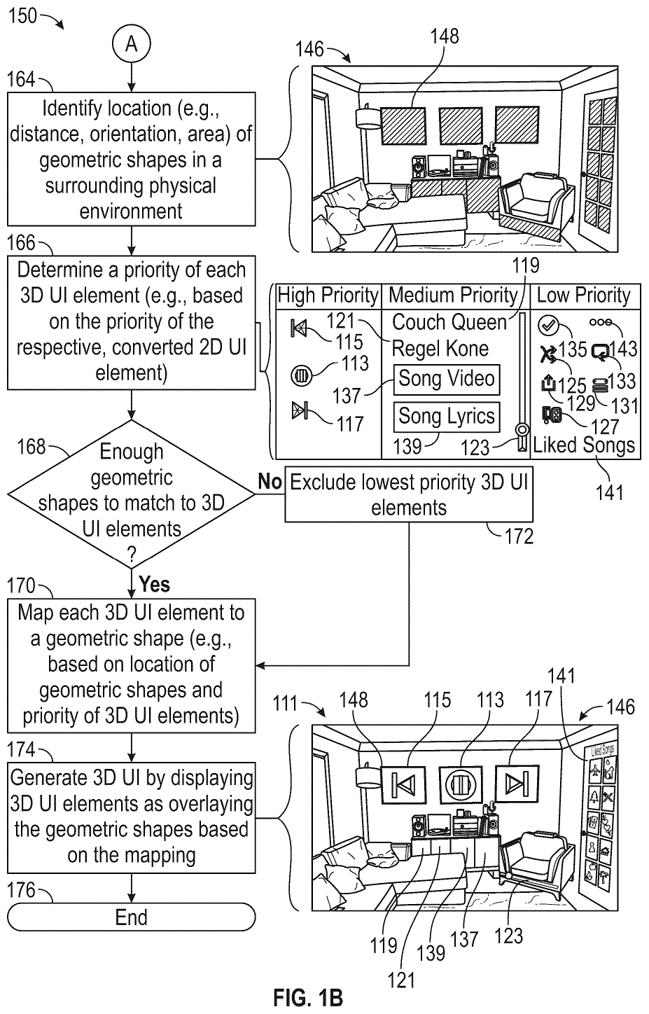

FIGS. 1A and 1B are schematic illustrations of a process 150 for using a system 100 to generate a 3D UI 111 based on a 2D UI 110, in accordance with embodiments of the disclosure.

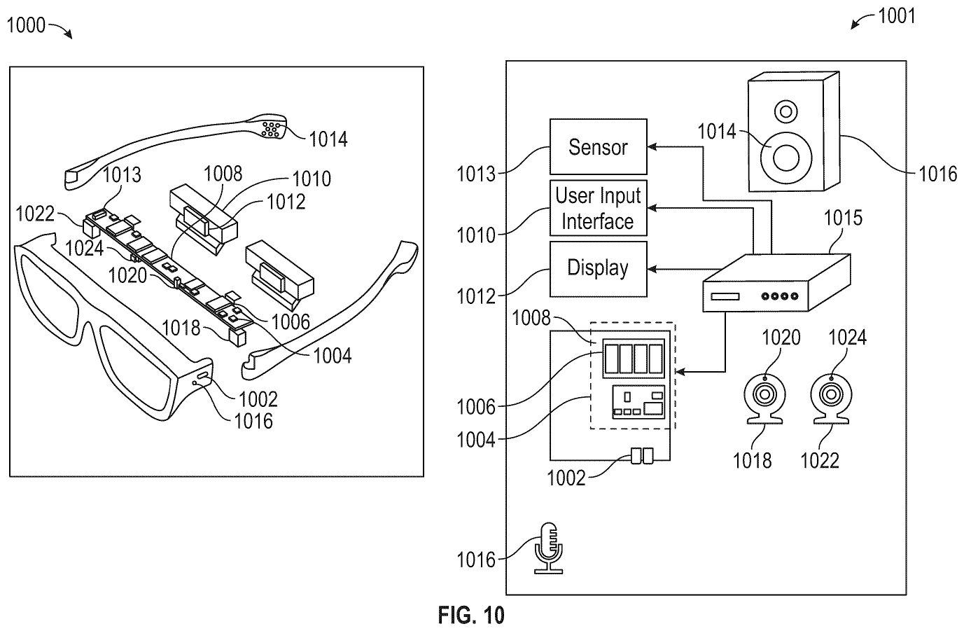

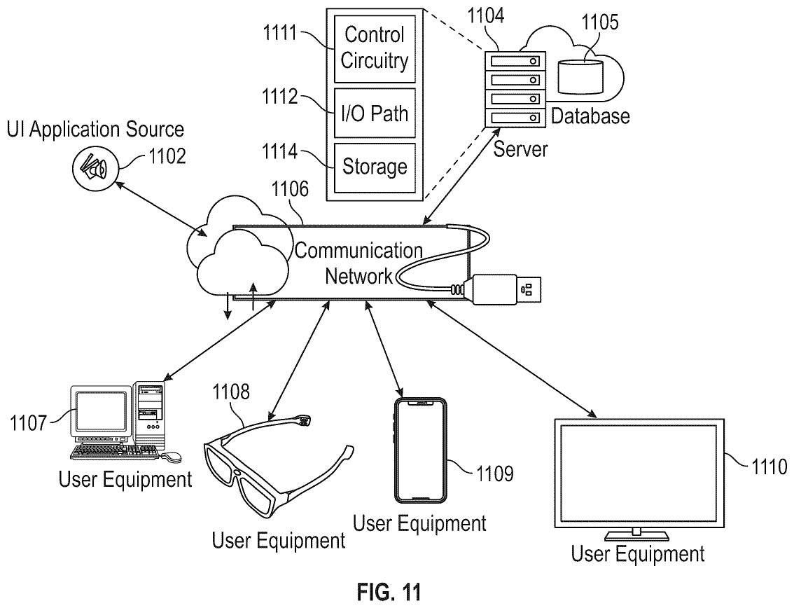

Referring to FIG. 1A, the process 150 starts at operation 152 with control circuitry 190 (or, e.g., control circuitry 1004, 1111, discussed below in relation to FIGS. 10 and 11) initializing the system 100. In some embodiments, the control circuitry 190 executes the system 100, which includes an XR device 102, at least one sensor 108 (or, e.g., sensors 1013, discussed below in relation to FIG. 10), the control circuitry 190, and input/output (I/O) circuitry 192 (or, e.g., I/O path 1002, 1112, discussed below in relation to FIGS. 10 and 11). The I/O circuitry 192 receives input from the sensors 108.

In some embodiments, the sensors 108 sense various conditions about the environment surrounding the XR device 102. For example, the sensors 108 may be used for any one of detecting nearby objects (e.g., furniture, furnishings, fixtures, or a person), determining a proximity of (e.g., distance to) the nearby objects to the XR device 102, or tracking motion of the nearby objects in relation to the XR device 102. In the embodiments depicted in FIG. 1B, the environment surrounding the XR device 102 is a surrounding physical environment 146. In some embodiments, the environment includes a virtual environment or world. The sensors 108 may include any one or combination of ultrasonic sensors, cameras, radar, lidar, or any other sensors capable of detecting the presence of objects, capturing a shape of the objects, detecting a color, or detecting the proximity of the XR device 102 to the objects or other features in the surrounding physical environment 146. In some embodiments, the sensors 108 enable the XR device 102 to position elements of an application UI within the surrounding physical environment 146.

In some embodiments, the XR device 102 includes systems (e.g., user input interface 1010, discussed below in relation to FIG. 10) to accept input from a user (e.g., a user wearing the XR device 102). In the embodiment depicted in FIG. 1A, the XR device 102 includes a display 104 (e.g., display 1012, discussed below in relation to FIG. 10) to display content to the user and overlay the content over the surrounding physical environment 146. The XR device 102 receives input commands or preferences or selections of options from a user. In some embodiments, the XR device 102 includes or interfaces with a user device (e.g., user equipment device 1107, 1109, 1110, discussed below in relation to FIG. 11). In some implementations, the user device is of the user of the XR device 102 or a user of another device. In one example, the user device runs a system interface application to accept input from the user and to communicate with the control circuitry 190. In some embodiments, the XR device 102 includes the sensors 108. In some implementations, the control circuitry 190 communicates with the user device and/or the sensors 108 through the I/O circuitry 192.

In some embodiments, the control circuitry 190 resides in or on the XR device 102. The system 100 includes several applications to control the XR device 102, or the display of the XR device, based on the inputs. For example, the control circuitry 190, by running the system 100 (or, e.g., the system interface application), processes computer-executable instructions to analyze the input from the sensors 108 and/or the XR device 102 to determine placement for digitally produced content, such as elements of a UI. In some examples, the applications are stored in a non-transitory memory (e.g., storage 1008, 1114, discussed below in relation to FIGS. 10 and 11), which may be local storage on the XR device 102 or off-device storage. In some implementations, instructions for the applications are stored in the non-transitory memory, and when executed, perform the operations of the process 150. The control circuitry 190 includes processing circuitry (e.g., processing circuitry 1006, discussed below in relation to FIG. 10) to process input to the control circuitry 190 (e.g., data and computer-executable instructions), store data to the non-transitory memory, and output results. In some implementations, the system 100 includes a computer (e.g., device 1001 1107, discussed below in relation to FIGS. 10 and 11) having the non-transitory memory with non-transitory instructions, that when executed, cause the execution of the applications. In one example, the control circuitry 190 and I/O circuitry 192 are part of the computer having the non-transitory memory.

In some embodiments, the instructions are provided by the control circuitry 190 through the I/O circuitry 192. A UI conversion application executes on the control circuitry 190 to provide instructions to the control circuitry 190 to perform the operations of process 150. In some embodiments, the control circuitry 190 executes the UI conversion application to perform the operation 152. In some embodiments, the UI conversion application interfaces with the other applications to carry out its functions. The control circuitry 190 also executes the system interface application to communicate with the sensors 108, the XR device 102, and/or the user device through the I/O circuitry 192. In some embodiments, the system interface application interfaces with the other applications to carry out its functions. In some embodiments, the control circuitry 190 executes the system interface application to communicate with the user device. The control circuitry 190 is capable of sending and receiving communications over a communications network (e.g., communications network 1106, discussed below in relation to FIG. 11) to communicate with any of the sensors 108, the XR device 102, the user device, or other devices, to name a few examples.

The control circuitry 190 also executes a 2D UI analysis application to identify elements of a 2D UI (e.g., 2D UI 110). The control circuitry 190 also executes a 3D UI element application to identify or generate elements of a 3D UI (e.g., 111) corresponding to the elements of the 2D UI. The control circuitry 190 also executes a priority determination application to determine a priority of the elements of the 2D and/or 3D UI. The control circuitry 190 also executes an environmental analysis application to analyze an environment surrounding the XR device 102 (e.g., surrounding physical environment 146). The control circuitry 190 also executes a mapping application to map UI elements to one another, map UI elements to the surrounding physical environment 146, or map objects within the surrounding physical environment 146 to one another. The control circuitry 190 also executes a grouping application to identify groups of UI elements or identify groups of objects within the surrounding physical environment 146.

In some embodiments, the control circuitry 190 communicates with a server (e.g., server 1104, discussed below in relation to FIG. 11) and at least part of at least one of the applications runs on a server, such as discussed in relation to FIG. 11. In some implementations, the instructions for the applications are stored on the server.

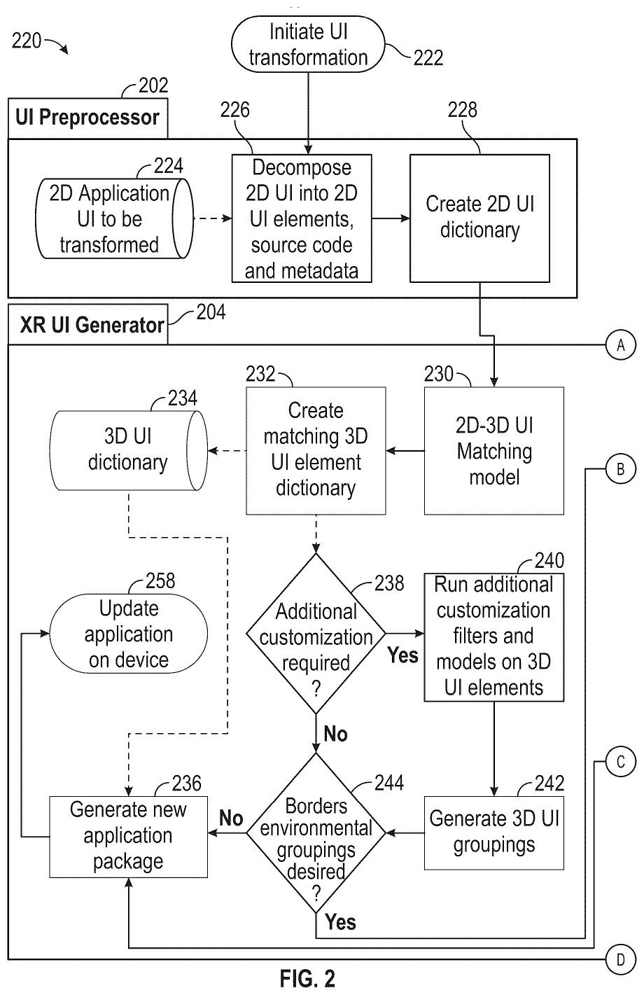

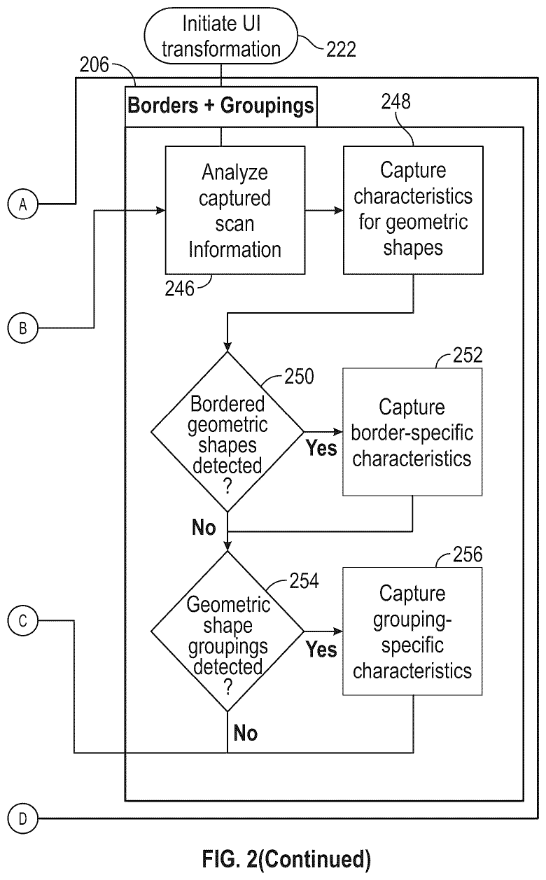

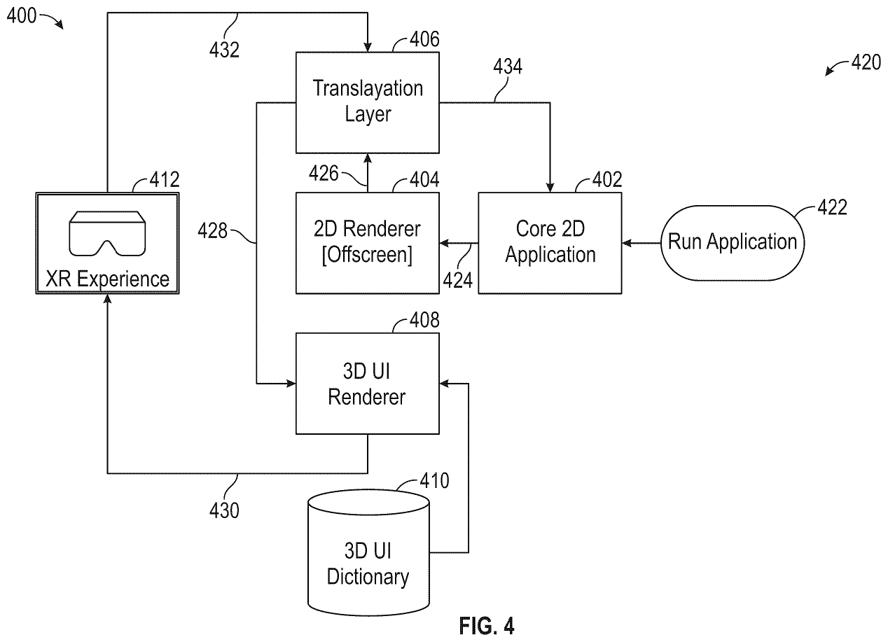

The process 150 continues to operation 154 with the control circuitry 190 (or, e.g., I/O circuitry 192) accessing a 2D UI 110 of a 2D UI application (e.g., 2D application UI 224, core 2D application 402, described below in relation to FIGS. 2 and 4) and identifying elements of the 2D UI 110 (e.g., by executing the 2D UI analysis application). In some embodiments, the I/O circuitry 192 accesses the 2D UI 110. In some embodiments, the 2D UI 110 was developed for display on a user device having a 2D touch screen. In such embodiments, the user device receives an input from a user through the 2D UI, such as an interaction, selection, or otherwise manipulation of a 2D UI element. In the embodiment depicted in FIG. 1A, the 2D UI 110 is an audio-playing application UI and includes 2D UI elements 112-142 (even numbers) for play/pause 112, previous song 114, next song 116, song title 118, artist name 120, progress bar 122, shuffle play 124, cast to device 126, share song 128, playlist editor 130, repeat song 132, favorite indicator 134, song video 136, song lyrics 138, liked songs 140, and additional options 142. Interacting with the 2D UI elements 112-142 (even numbers) may trigger an event (e.g., change the current song) or adjust a variable (e.g., volume). In the depicted embodiment, the song title 118 is “Couch Queen” and the artist name “Regel Kone”.

In some embodiments, interacting with the play/pause 112 2D UI element causes playback of a song or pauses playback of the song. Interacting with the previous song 114 2D UI element causes playback the previously played song, the previous song on the current album, or the previous song on the current playlist. Interacting with the next song 116 2D UI element causes playback the next song on the current album or the next song on the current playlist. The song title 118 and artist name 120 2D UI elements are for presenting information about the current song. In some embodiments, interacting with the song title 118 and artist name 120 2D UI elements may display other songs on the current album, similar songs, or other albums by the same artist, to name a few examples. Interacting with the progress bar 122 2D UI element changes playback of the current song to play from a different time stamp. In one example, the progress bar 122 is a slider and sliding a handle of the slider changes the time at which the current song is played.

In some embodiments, interacting with the shuffle play 124 2D UI element activates or deactivates playback of the current album or playlist in a random order. Interacting with the cast to device 126 2D UI element presents a new UI screen to select a device (e.g., speaker) from which to play the current song. Interacting with the share song 128 2D UI element presents a new UI screen to share the current song through other application UIs (e.g., text messaging and social media). Interacting with the playlist editor 130 2D UI element adds the current song to a playlist. In some embodiments, a new UI screen is presented to select an existing playlist to add the current song or to create a new playlist. Interacting with the repeat song 132 2D UI element activates or deactivates playback of the current song on a continuous loop. Interacting with the favorite indicator 134 2D UI element adds the current song to a favorites list or playlist.

In some embodiments, the song video 136 2D UI element is for presenting a video associated with the current song. In some implementations, the video is the music video for the current song. In some embodiments, the content of the video is related to the current song (e.g., related to the lyrics, artist, or genre). In some implementations, the song video includes album art for the current song. In some implementations, the song video 136 includes lyrics for the current song. In some embodiments, interacting with the song video 136 2D UI element presents the video or related videos in a new UI screen. In some embodiments, the song lyrics 138 2D UI element is for presenting lyrics corresponding to the current song. In some implementations, the song lyrics 138 overlays the song video 136. In some implementations, the song lyrics 138 sync to the lyrics at the current time stamp in playback. In one example, the lyrics at the current time stamp are styled differently than lyrics at a previous or upcoming timestamp so a user may follow along.

In some embodiments, interacting with the liked songs 140 2D UI element presents a new UI screen containing other songs that were “liked” by the user. Interacting with the additional options 142 2D UI element presents a new UI screen containing additional options for the current song, album, or playlist, or artist.

The process 150 continues to operation 156 with the control circuitry 190 identifying properties of each 2D UI element 112-142 (even numbers). In one example, the control circuitry 190 may identify functionality by identifying what variables are changed by interacting with the 2D UI elements 112-142 (even numbers). In another example, any of the priority, shape, and color of each 2D UI element is identified. The color identified may be an average color (e.g., RGB), median color, dominant color, or prevalent color.

In some embodiments, the properties of the 2D UI elements 112-142 (even numbers) are identified by analyzing the 2D UI application's compiled code. In some embodiments, the properties of the 2D UI elements 112-142 (even numbers) are identified by running the 2D UI application in a UI simulation to evaluate the UI. In some embodiments, any reverse engineering techniques known to one skilled in the art may be used to identify the functionality.

In some embodiments, the control circuitry 190 sorts the 2D UI elements 112-142 (even numbers) into different subsets or groups based on their functionality. In some embodiments, the subsets are based on how the functionality impacts a current task, action, or activity in the 2D UI 110. In one example, one of the subsets includes 2D UI elements 112-142 (even numbers) that control playback of the current song and another subset includes 2D UI elements 112-142 (even numbers) that control playback of the current album or playlist.

The process 150 continues to operation 158 with the control circuitry 190 determining whether each 2D UI element 112-142 (even numbers) is mapped to a corresponding three-dimensional (3D) UI element (e.g., 3D UI elements 113-143 (odd numbers) in FIG. 1B) (e.g., by executing the 3D UI element application or the mapping application). For example, the control circuitry 190 may determine the 2D UI elements 112-142 (even numbers) of the 2D UI have already been mapped to 3D UI elements by using metadata of the 2D UI or searching a library or database associating the 2D UI with 3D UI elements. If the determination at operation 158 is no, then the process 150 continues to operation 160 with the control circuitry 190 converting the 2D UI elements 112-142 (even numbers) to 3D UI elements (e.g., by executing the 3D UI element application). In some implementations, the control circuitry 190 looks up an existing 3D UI element for each 2D UI element 112-142 (even numbers) in a library or database. In one example, the control circuitry 190 uses the functionality of each 2D UI element 112-142 (even numbers) to map to an existing 3D UI element having the same or similar functionality. In one example, the progress bar 122 2D UI element is mapped to a 3D UI element that may be manipulated to adjust settings along a scale. In some implementations, the control circuitry 190 generates 3D versions of the 2D UI elements to create the 3D UI elements.

If the determination at operation 158 is yes, then the process 150 continues to operation 162 with the control circuitry 190 using the mapping of the corresponding 3D UI elements (e.g., by executing the 3D UI element application).

The process 150 continues to operation 164 with the control circuitry 190 identifying a location of geometric shapes 148 in the surrounding physical environment 146 (e.g., by executing the environmental analysis application). In some embodiments, the geometric shapes 148 correspond to objects in the surrounding physical environment 146. In some implementations, each geometric shape 148 is a plane in 3D space that is formed by a surface(s) of the objects. In the embodiment depicted in FIG. 1B, a chair (e.g., recliner) is one of the objects and the geometric shape 148 corresponds to a lower portion of the front of the recliner (e.g., the movable footrest). The lower portion forms a plane that is angled in relation to the XR device 102 and in the FOV.

In some embodiments, the control circuitry 190 receives data from the sensors 108, such as images or 3D spatial data of the surrounding physical environment 146, and identifies the geometric shapes 148 based on the data. In some implementations, the control circuitry 190 identifies the objects in the surrounding physical environment 146, based on the sensor data, that are used to determine corresponding geometric shapes 148. In some examples, the border of at least a portion of the objects (e.g., a visible portion) is determined and corresponding geometric shapes 148 are identified. In the embodiment depicted in FIG. 1B, a TV stand is one of the objects and the geometric shape 148 corresponds to the middle cabinet door of the TV stand. A couch is positioned in front of the cabinet door and the corresponding geometric shape 148 is formed by the border of the visible portion of the cabinet door and the border of a portion of the couch that obstructs the cabinet door.

In some implementations, the geometric shapes 148 are closed shapes formed by the objects in the surrounding physical environment 146. In one example, the closed shapes are formed by the perimeter border of the objects. In another example, the geometric shapes 148 are formed by openings or recesses formed by or within the object, such as the windowpanes within the door. In another example, the geometric shapes 148 are shapes formed within the FOV of the XR device 102 and are identified using only visible portions of the objects. In some implementations, the geometric shapes 148 include any of polygons, irregular polygons, conics, curves, or amorphous shapes.

In the embodiment depicted in FIG. 1B, the surrounding physical environment 146 is a living room. the control circuitry 190 identifies the geometric shapes 148 corresponding to picture frames on a wall, cabinet doors of a TV stand, a recliner, and windowpanes of a door. The geometric shapes 148 corresponding to the picture frames have a larger area in the FOV than the other geometric shapes 148. The geometric shapes 148 corresponding to two of the three cabinet doors are partially obscured by a sectional couch. The geometric shapes 148 corresponding to the recliner and the windowpanes of the door are oriented at an angle to the XR device 102. Other objects in the living room include a floor lamp, couch pillows, and area rug. For simplicity of illustration, no geometric shapes 148 are shown corresponding to these items. In some implementations, geometric shapes 148 may be identified that correspond to any of the other objects.

In some implementations, the control circuitry 190 determines the total number of geometric shapes 148. In some embodiments, the control circuitry 190 determines a subset of the geometric shapes 148 that is suitable for use to overlay a 3D UI element. For example, the geometric shapes 148 may be required to have any of an size greater than a viable size threshold, a distance less than a viable distance threshold, an orientation within a viable orientation threshold, or to be stationary, to name a few examples. In some implementations, the viable size threshold is based on an angular unit. In some examples, the angular unit is a unit that remains constant or is unaffected by the distance of the geometric shapes 148 from the XR device 102. In one example, the angular unit is a distance-independent millimeter (DMM) that represents 1 millimeter viewed at 1 meter away. In some examples, the size of the geometric shapes 148 is the DMM along any of (i) at least one dimension (e.g., vertical or horizontal) of the geometric shape 148, (ii) the smallest dimension, or (iii) an average dimension. The viable size threshold is at least 10 DMMs, such as at least 20 DMMs, such as at least 24 DMMs, such as at least 64 DMMs, such as at least 96 DMMs. In some implementations, the viable distance threshold is at least 50 ft, such as at least 20 ft, such as at least 10 ft. In some implementations, the viable orientation threshold is used to ensure 3D UI elements mapped to the geometric shapes are clearly visible to the user of the XR device 102. In some embodiments, the viable orientation threshold is an angle in relation to the XR device 102 is less than 90 degrees, such as less than 80 degrees, such as less than 70 degrees. In one example, the angle of the geometric shape 148 corresponding to the footrest of the recliner in FIG. 1B is 45 degrees and within the viable orientation threshold.

In some implementations, the location includes the distance from the geometric shape to the XR device 102 (e.g., in 2D or 3D space). In some embodiments, the control circuitry 190 determines the orientation of the geometric shape 148 in the surrounding physical environment 146. In one example, the orientation includes the angle of a plane formed by the geometric shape in relation to the XR device 102. In some embodiments, the control circuitry 190 identifies a color(s) or prevalent color associated with each geometric shape (e.g., the color of the corresponding object). In some implementations, the control circuitry 190 determines a border of the geometric shape. In one example, the thickness of the object immediately surrounding or adjacent to the border is determined. In some implementations, the control circuitry 190 determines the area of the geometric shape.

In some embodiments, the control circuitry 190 sorts the geometric shapes 148 into different groups, subgroups, or subsets based on their location. In some embodiments, the subsets are based on the distance to the XR device 102. In some embodiments, the subsets are based on the area of the geometric shapes 148 in the FOV of the XR device 102.

The process 150 continues to operation 166 with the control circuitry 190 determining a priority of each 3D UI element 113-143 (odd numbers) (e.g., by executing the priority determination application). In some implementations, the priority is determined based on the priority of the respective, converted 2D UI element 112-142 (even numbers). In one example, metadata for each 2D UI element is used to determine the priority. In another example, a manifest file or meta document for the 2D UI is used to determine the priority.

In the embodiment depicted in FIG. 1B, the 3D UI elements 113-143 (odd numbers) are shown sorted into three priority groups of high priority, medium priority, and low priority based on a functionality of the 3D UI element 113-143 (odd numbers) (or, e.g., the corresponding 2D UI element 2D UI element 112-142 (even numbers)). The 3D UI elements 113-143 (odd numbers) correspond to the 2D UI elements 112-142 (even numbers). Play/pause 113 3D UI element corresponds to play/pause 112 2D UI element, previous song 115 3D UI element corresponds to previous song 114 2D UI element, next song 117 3D UI element corresponds to next song 116 2D UI element, and so forth. The 3D UI elements 113, 115, and 117 are in the high-priority group. The 3D UI elements 119, 121, 123, 137, and 139 are in the medium priority group. The 3D UI elements 125, 127, 129, 131, 133, 135, 141, and 143 are in the low-priority group.

In some embodiments, the priority includes a sequential, individual ranking of the 3D UI elements 113-143 (odd numbers). In one example, the 3D UI elements 113-143 (odd numbers) within the same priority group may have different priority rankings.

In some embodiments, the priority is determined based on an input received from the user. In one example, the input assigns the priority. In some embodiments, the priority is based on historical data, such as a frequency of interaction with the 3D UI element 113-143 (odd numbers) or corresponding 2D UI element 112-142 (even numbers). In some implementations, a user profile is used to determine the priority. In one example, the user profile includes the priority for each 2D or 3D UI element. In some implementations, user profiles for several users are used to determine a collective priority amongst multiple users. In some examples, the multiple users are users of the 2D or 3D UI. In some examples, the multiple users are a subset of users that are most similar to the particular user.

In some embodiments, the priority is determined based on a spatial relationship of a respective 2D UI element 112-142 (even numbers) in the 2D UI 110 to other 2D UI elements in the 2D UI. In some embodiments, the priority is determined based on groupings of the 2D UI elements 112-142 (even numbers). In some implementations, the grouping is based on the spatial relationship. In some examples, 2D UI elements 112-142 (even numbers) are grouped together if within a distance from one another that is less than an element group threshold. In some embodiments, the element group threshold is a percentage of the 2D UI 110 located between the 2D UI elements 112-142 (even numbers). In some examples, the element group threshold is 10% or less, such as 5% or less, such as 1% or less. In some implementations, the percentage is based on overall dimensions of the 2D UI 110. In some examples, the element group threshold may differ for percentages of the vertical and horizontal measurements of the 2D UI 110. In one example, if the 2D UI 110 is 1920 height×1080 width, then the element group threshold for the horizontal spatial relationships is 10% or less, such as 5% or less, such as 1% or less, and the element group threshold for the horizontal spatial relationships is 6% or less, such as 3% or less, such as 0.6% or less. In some embodiments, the element group threshold is an angular unit of the 2D UI 110 located between the between 2D UI elements 112-142 (even numbers), such as described above with respect to the viable size threshold. In some implementations, the angular unit is a DMM and the element group threshold is 75 DMM or less, such as 50 DMM or less, such as 25 DMM or less, such as 10 DMM or less. In some embodiments, a higher priority is assigned to groups of 2D UI elements 112-142 (even numbers), such as groups of 2D UI elements closer together.

The process 150 continues to operation 168 with the control circuitry 190 determining whether there are enough geometric shapes 148 to match each of the 3D UI elements 113-143 (odd numbers) (e.g., by executing the mapping application). In one implementation, the control circuitry 190 determines whether the number of geometric shapes 148 that are suitable for overlaying a 3D UI element 113-143 (odd numbers) is equal to or exceeds the number of 3D UI elements 113-143 (odd numbers) to display. If the determination at operation 168 is yes, the process 150 continues to operation 170 with the control circuitry 190 mapping each 3D UI element 113-143 (odd numbers) to one of the geometric shapes 148 (e.g., by executing the mapping application).

In some implementations, the mapping is based on the location of geometric shapes 148 and the priority of 3D UI elements 113-143 (odd numbers). In some embodiments, the mapping is based on color. In some implementations, the 3D UI elements 113-143 (odd numbers) are mapped to the geometric shapes 148 based on their associated prevalent color. In some examples, the control circuitry 190 determines a contrast ratio of the prevalent colors of the 3D UI elements 113-143 (odd numbers) and the geometric shapes 148, and the mapping is based on the contrast ratio exceeding a contrast threshold. In some examples, the contrast threshold is selected such that the 3D UI elements 113-143 (odd numbers) is visually distinct from the geometric shape 148. In some examples, the contrast threshold is a contrast ration of at least 3, such as at least 4.5, such as at least 6.

In some embodiments, the mapping is based on subsets of the 3D UI elements 113-143 (odd numbers) and subsets of the geometric shapes 148. In some implementations, the subsets of the 3D UI elements 113-143 (odd numbers) are based on their functionality. In some implementations, the subsets of the geometric shapes 148 is based on their location in the surrounding physical environment 146. In some implementations, the subsets of the geometric shapes 148 are based on their area in the FOV. In some examples, a subset of high-priority UI elements is mapped to a subset of geometric shapes 148 having an area greater than a prominent area threshold, even if a geometric shape in the subset is a greater distance from the XR device 102 than geometric shapes 148 in other subsets. In one example, the prominent area threshold is at least 7 sq. ft., such as at least 8.5 sq. ft., such as at least 10 sq. ft. In another example, the prominent area threshold is based on a percentage of the FOV and is at least 2.25% of the FOV, such as at least 5%, such as at least 8%.

In some embodiments, the sensors 108 include a camera(s), the sensor data includes an image(s), and the control circuitry 190 determines a saliency map of the image (or, e.g., calculates a saliency score for portions of the image). In some examples, the portions of the image correspond to objects in the surrounding physical environment 146. The saliency map and the saliency score characterize objects in, or portions of, the image that will draw the gaze or attention of a viewer (e.g., the user of the XR device 102). In one example, the subset of high-priority UI elements is mapped to a subset of geometric shapes 148 corresponding to an object in, or area of, the image having a saliency value (e.g., average or mean) greater than a saliency threshold.

In some embodiments, the mapping includes manipulating or altering the 3D UI elements 113-143 (odd numbers). In one example, the mapping includes adjusting the orientation of the 3D UI elements 113-143 (odd numbers) to match the orientation of the respective geometric shapes 148.

If the determination at operation 168 is no, the control circuitry 190 proceeds to operation 172 with the control circuitry excluding the lowest priority 3D UI elements 113-143 (odd numbers) (e.g., by executing the priority determination application or the 3D UI element application). In some embodiments, the lowest priority 3D UI elements 113-143 (odd numbers) are determined using a priority ranking. In some embodiments, 3D UI elements 113-143 (odd numbers) may be excluded based on an input received from the user. In some embodiments, 3D UI elements 113-143 (odd numbers) may be excluded based on a frequency of use such that lesser used elements are excluded. In some implementations, the control circuitry 190 may access a user profile to determine frequency of use for a particular user. In some implementations, the control circuitry 190 may access several user profiles to determine a collective frequency of use amongst multiple users. In some examples, the multiple users are users of the 2D UI. In some examples, the multiple users are a subset of users most similar to the particular user. The process 150 continues to operation 170.

The process 150 continues to operation 174 with the I/O circuitry 192 (or, e.g., control circuitry 190) generating the 3D UI 111 for display by displaying 3D UI elements 113-143 (odd numbers) as overlaying the geometric shapes 148 based on the mapping (e.g., by executing the UI conversion application). For example, the 3D UI elements 113-143 (odd numbers) are displayed on the display 104 of the XR device 102 such that they overlay the objects corresponding to the geometric shapes 148. In the embodiment depicted in FIG. 1B, the low priority 3D UI elements 113-143 (odd numbers) are excluded based on the number of geometric shapes 148 (e.g., there are less geometric shapes than 3D UI elements 113-143 (odd numbers)). The play/pause 113, previous song 115, and next song 117 3D UI elements are displayed over rectangular geometric shapes 148 corresponding to the picture frames. In one example, the geometric shapes 148 corresponding to the picture frames have an area greater than a prominent area threshold. In some embodiments, the I/O circuitry 192 generates the 3D UI 111 for display.

In some embodiments, the high priority play/pause 113, previous song 115, and next song 117 3D UI elements are mapped to the geometric shapes 148 corresponding to the picture frames based on the thresholds. The song title 119 and artist name 121, song video 137, and song lyrics 139 are each displayed over polygonal and irregular polygonal geometric shapes 148 corresponding to the cabinet doors of the TV stand. The geometric shapes 148 corresponding to the cabinet doors are positioned at locations in the living room and in the FOV in which a user is likely to look (e.g., have a saliency value greater than a saliency threshold), and are within a distance from one another that is less than a shape group threshold. In some embodiments, the saliency map comprises values ranging from 0 to 1 and the saliency threshold is a saliency value of at least 0.4, such as at least 0.6, such as at least 0.8. In some embodiments, the saliency map is a heat map and areas or clusters of the heat map having the greatest values are identified as the locations where the user is likely to look. In some embodiments, the shape group threshold is less than 2 ft, such as less than 1 ft, such as less than 0.5 ft, such as less than 0.2 ft.

In some embodiments, the song title 119 and artist name 121, song video 137, and song lyrics 139 (i) convey visual information related to the current song, (ii) are part of the same subset of 3D UI elements 113-143 (odd numbers), and (iii) are mapped to the geometric shapes 148 corresponding to the cabinet doors based on the proximity of the geometric shapes 148 to one another. The progress bar 123 is displayed over a rectangular geometric shape 148 corresponding to a lower, front portion of the recliner. The liked songs 141 are displayed as single cover artwork in the windowpanes of the door. The geometric shapes 148 corresponding to the windowpanes are positioned outside of locations in which a user is likely to look (e.g., have a saliency value less than a saliency threshold), and are within the shape group threshold from one another. In some embodiments, the liked songs 141 are mapped to the geometric shapes 148 based on the locations and proximity of the geometric shapes 148. In some implementations, a portion of the total liked songs 141 are mapped since the number of geometric shapes 148 corresponding to the windowpanes are less than the number of liked songs 141.

In some implementations, the 3D UI elements 113-143 (odd numbers) are displayed within a border of the geometric shapes 148. In some implementations, the 3D UI elements 113-143 (odd numbers) are manipulated to fit to or stretch to the border of the geometric shapes 148. In some implementations, the 3D UI elements 113-143 (odd numbers) are displayed over the entirety of and beyond a border of the geometric shapes 148.

The process 150 concludes to operation 176.

In some embodiments, the control circuitry 190 groups at least a portion of the geometric shapes 148, such as discussed below in relation to operations 254, 256 in FIG. 2. In some implementations, the geometric shapes 148 corresponding to the windowpanes of the door are part of one group based on their proximity to one another. In some implementations, the geometric shapes 148 corresponding to the windowpanes are grouped based on being formed within the same door. In some implementations, the group of geometric shapes 148 is accounted for when mapping the 3D UI elements to 113-143 (odd numbers) to the geometric shapes 148. In one example, the liked songs 141 3D UI element(s), which includes album art linked to songs that were identified as “liked,” are mapped to the geometric shapes 148 corresponding to the windowpanes because the geometric shapes 148 are part of a group.

In some embodiments, the control circuitry 190 determines the surrounding physical environment 146 has changed (e.g., from a first surrounding physical environment to a second surrounding physical environment). In some implementations, the control circuitry 190 executes the operations 164-176 for the new surrounding physical environment 146. For example, the control circuitry 190 identifies the location of geometric shapes 148 in the new surrounding physical environment 146, maps the 3D UI elements 113-143 (odd numbers) to the geometric shapes 148, and displays the 3D UI elements 113-143 (odd numbers) based on the location of the geometric shapes 148 and the priority of the 3D UI elements 113-143 (odd numbers).

In some embodiments, the respective location of each of a plurality of geometric shapes 148 and the mapping of each 3D UI element 113-143 (odd numbers) to the respective geometric shape 148 is stored in the non-transitory memory. In some implementations, the control circuitry 190 determines the XR device 102 has left and returned to the surrounding physical environment 146. The control circuitry 190 re-generates each 3D UI element 113-143 (odd numbers) to overlay the saved, mapped respective geometric shape 148. In some embodiments, the I/O circuitry 192 re-generates the 3D UI 111 for display.

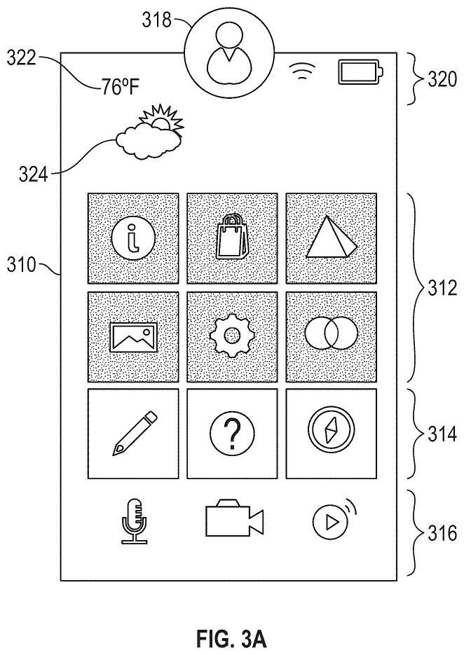

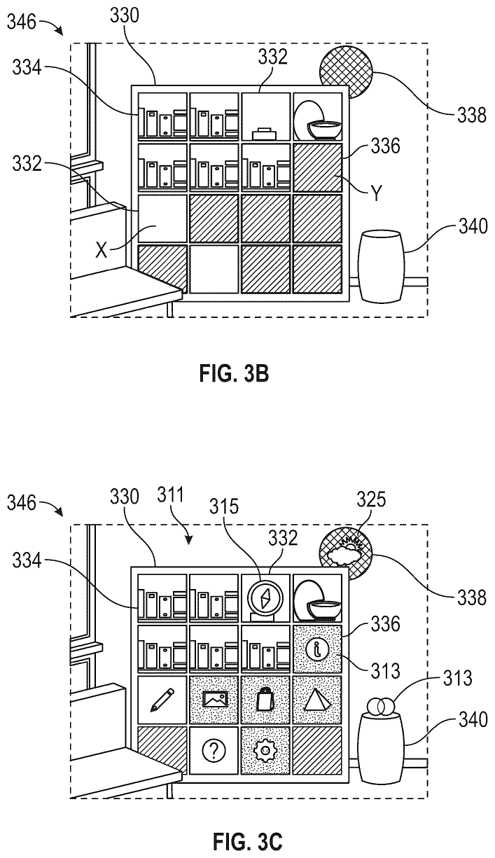

FIG. 2 is a flowchart of a detailed illustrative process 220 for generating a 3D UI (e.g., 3D UI 111 in FIG. 1B, and 3D UI 311, 611, 711, discussed below in relation to FIGS. 3C, 6, and 7) based on a 2D UI (e.g., 2D UI 110 in FIG. 1A, and 2D UI 310, discussed below in relation to FIG. 3A), in accordance with embodiments of the disclosure. FIGS. 3A-3C are schematic illustrations of the process 220 for generating a 3D UI based on a 2D UI, in accordance with embodiments of the disclosure. Therefore, FIG. 2 and FIGS. 3A-3C are herein described together for clarity.

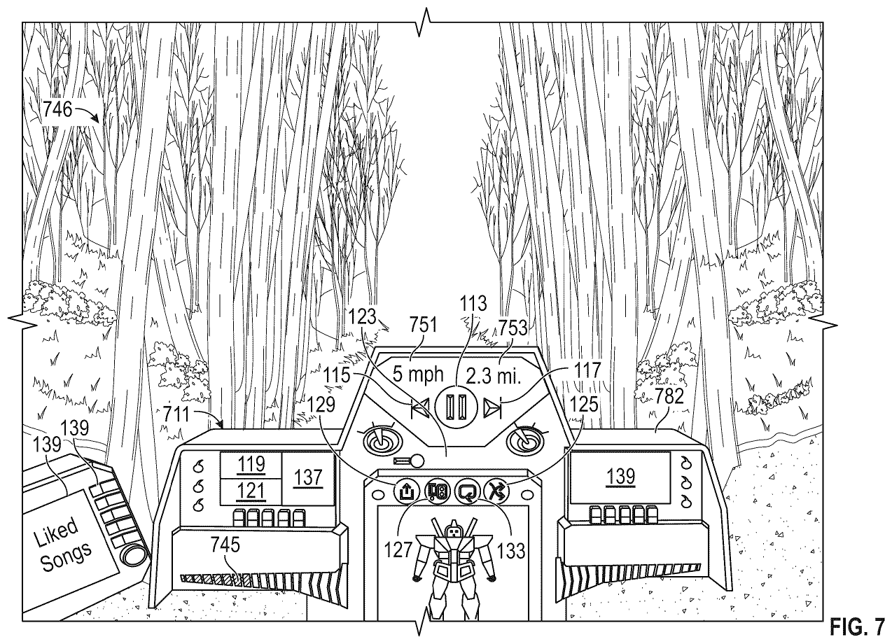

Referring to FIG. 2, in some embodiments, a system (e.g., system 100 in FIG. 1A and system 400, discussed below in relation to FIG. 4) performs operations of the process 220. In some implementations, the system comprises a 2D UI preprocessor 202, an XR UI generator 204, and a run-time translation service. The UI preprocessor 202 decomposes a 2D UI of a 2D application UI 224. The XR UI generator 204 generates a 3D UI based on any of the type of application UI, user customization/preferences, generative artificial intelligence (AI) output, or spatial mapping of the surrounding physical environment (e.g., surrounding physical environment 146 in FIG. 1B, and surrounding physical environment 346, 746, discussed below in relation to FIGS. 3B and 3C and 7). The run-time translation service, discussed below in relation to FIG. 4, coordinates interactions and updates between the 2D UI and the 3D UI. In some embodiments, the UI conversion application executes the operations of the process 220. In some implementations, the UI conversion application executes any one of the 2D UI preprocessor 202, XR UI generator 204, or run-time translation service.

The process begins at operation 222 with I/O circuitry (e.g., I/O circuitry 192 in FIG. 1A or I/O path 1002, 1112, discussed below in relation to FIGS. 10 and 11) of the system receiving a request to initiate a 2D UI to 3D UI transformation (e.g., by executing the system interface application). In some embodiments, the request is received as an input from a user. In some embodiments, the request is received from an XR device (e.g., XR device 102 in FIG. 1A and user equipment device 1000, 1108, discussed below in relation to FIGS. 10 and 11). In one example, the request is sent by the XR device when starting the 2D application UI 224.

The process 220 continues to operation 226 with control circuitry (e.g., control circuitry 190 in FIG. 1A and control circuitry 1004, 1111, discussed below in relation to FIGS. 10 and 11) of the system executing the UI preprocessor 202 to decompose the 2D UI of the 2D application UI 224 into 2D UI elements (or, e.g., by executing the 2D UI analysis application). In some embodiments, the UI preprocessor 202 executes the 2D UI analysis application. In some embodiments, the control circuitry evaluates the 2D UI to identify 2D UI elements (e.g., icons, text) and their functionality (e.g., pressing a button triggers an event, moving a slider adjusts a variable). The UI preprocessor 202 may decompose the 2D UI in different ways depending on the type of application UI. In some embodiments, the UI preprocessor 202 is part of an operating system of a device running the 2D application UI 224 or a tool that created the application 224. In one implementation, the UI preprocessor 202 analyzes the compiled code of the 2D application UI 224 for the appropriate application programming interface (API) functions and the data packages of the 2D application UI 224 to identify the 2D UI elements and UI element containers. In some implementations, the UI preprocessor 202 parses each 2D UI element to identify its functionality (e.g., logic and navigational functionality endpoints). In some examples, the logic and endpoints are mapped to 3D UI elements of a corresponding 3D UI to maintain a consistent UI experience between the 2D and 3D UIs.

In some embodiments, the 2D application UI 224 is written in an interpretive language (e.g., Python or JavaScript) and the UI preprocessor 202 converts the source code into a code language compatible with the XR UI generator 204. In some embodiments, the UI preprocessor 202 runs the 2D application UI 224 in a UI simulation to evaluate the 2D UI of the 2D application UI 224. In some implementations, the UI simulation is similar to web scraping and testing websites and enterprise application UIs.

In some embodiments, operation 226 results in a decomposed UI bundle containing the 2D UI elements and the associated source code for each 2D UI element describing the function of the 2D UI element and where the 2D UI element is located in the 2D application UI 224. In some implementations, the source code provides additional context when 2D UI elements are run through the XR UI generator 204. In one example, the translation service is provided by a translation layer (e.g., translation layer 406, discussed below in relation to FIG. 4) that translations the interactions between the 3D UI and 2D application UI 224, and the XR UI generator 204 informs the translation layer about the actions of the UI elements during runtime.

Referring to FIG. 3A, a 2D UI 310 is decomposed into 2D UI elements. The 2D UI elements include a group 312 of six darker-colored, square-bordered 2D UI elements; a group 314 of three lighter-colored, square-bordered 2D UI elements; a group 316 of three borderless 2D UI elements; user profile 318 2D UI element; device status 320 2D UI elements; and temperature 322 and weather 324 2D UI elements. The groups 312 and 314 are adjacent and form a single grid-like area of 2D UI elements. The group 316 is adjacent to the group 314 and includes communication 2D UI elements to turn on/off a microphone, turn on/off a video, and cast to a device. The group 320 is positioned in a status bar area of the 2D UI 310 and includes a wireless network (e.g., LTE, 5G, Wi-Fi) strength and a battery level.

Referring back to FIG. 2, the process 220 continues to operation 228 with the control circuitry executing the UI preprocessor 202 to create a 2D UI dictionary of operation 228. The 2D UI dictionary of operation 228 is a database or library containing the decomposed 2D UI elements and the associated logic and navigation source code and metadata generated during preprocessing. In some implementations, the metadata contains contextual data such as text, the type of UI element, variable values (e.g., a slider control may have a value of 0-10), possible interactions, and spatial and functional relations to other 2D UI elements, to name a few examples.

The process 220 continues to operation 230 with the control circuitry executing the XR UI generator 204 to use a 2D-3D UI matching model to map the 2D UI elements to 3D UI elements (or, e.g., by executing the 3D UI element application or the mapping application). In some embodiments, the XR UI generator 204 executes any of the 3D UI element application or the mapping application.

In some embodiments, the 2D-3D UI matching model is a trained machine learning (ML) model that converts the 2D UI elements into platform-appropriate 3D UI elements. In some implementations, the ML model is trained using 2D UI elements from different 2D application UIs 224, and in some examples, source code and metadata from the 2D application UIs 224. In some examples, the ML model is trained using images of the 2D UIs. In one example, 2D UI elements in the images are annotated. In some examples, the 2D UI elements are stored in the 2D UI element dictionary from operation 228. The 2D UI elements are classified using available 3D UI elements, such as from a 3D UI dictionary 234. In some embodiments, the 3D UI dictionary 234 is a library or database. In some implementations, the trained ML model provides a baseline translation between 2D UI elements and 2D UI elements. In some examples, the control circuitry modifies the baseline translation to refine the 3D UI. In one example, the control circuitry receives an input from a user, through the I/O circuitry, to modify the baseline translation.

In some embodiments, the XR UI generator 204 runs the 2D-3D UI matching model for a new 2D application UI 224 and outputs a 3D UI element for each 2D UI element input. In some implementations, the system adds the mapping of the 3D and 2D UI elements to the 3D UI dictionary 234 and the 2D UI dictionary of operation 228. In some implementations, the system updates the corresponding metadata and source code for the 3D UI elements to match the specific parameters of the 2D UI elements. In one example, the 2D UI element is a slider control having a range of values from 0 to 10 in the 2D UI and system updates the metadata for the mapped 3D UI element to have the same range. In some implementations, the ML classification model allows for the system generate the 3D UI without having to create a one-to-one relationship between the entirety of 2D UI elements from thousands of unique application 2D UIs and the 3D UI elements.

In some embodiments, the 2D-3D UI matching model uses a confidence threshold to map the 2D UI elements to 3D UI elements. In some implementations, the confidence threshold is at least 0.5, such as at least 0.6, such as at least 0.7. In some implementations, the 2D-3D UI matching model does not find a match that exceeds the confidence threshold. In one example, the 2D UI element is modified using a style diffusion model trained on a style sheet for the 3D UIs. The 2D UI element is modified to fit the look and feel of the 3D UI. In another example, a generative AI model creates the 3D UI element using images and metadata related to the 2D UI element with a 3D UI style sheet. In another example, the 2D UI element is used as the 3D UI element. The 2D UI element may be skewed to adjust its orientation in the surrounding physical environment.

In some implementations, the ML model is trained to translate the 2D UI elements, based on their functionality, to take advantage of both the 3D surrounding physical environment and tactile interactivity that the XR device provides over the 2D UI. In some embodiments, the trained ML model is a multi-modal classification model for determining how well a given image and a given text fit together.

In some embodiments, the I/O circuitry may receive, or map to, a library of 3D UI elements (e.g., existing 3D UI elements in the 3D UI dictionary 234). In some implementations, the 3D UI elements of the library contain metadata detailing their functionality (similar to the annotated 2D UI training data) and the 2D-3D UI matching model matches the functionality between 2D UI elements and the 3D UI elements of the library. In one example, the 2D-3D UI matching model prioritizes the matched 3D UI elements and eliminates the non-matching 3D UI elements. In some implementations, the 3D UI library does not include metadata and the 2D-3D UI matching model matches the 2D UI elements to 3D UI elements in the library.

The process 220 continues to operation 232 with the control circuitry executing the XR UI generator 204 to create a matching 3D UI dictionary 234 (or, e.g., by executing the 3D UI element application or the system interface application). In some embodiments, the XR UI generator 204 executes the system interface application.

The process 220 continues to operation 238 with the control circuitry executing the XR UI generator 204 to determine if additional customization is needed (or, e.g., by executing the 3D UI element application or the system interface application). If the determination at operation 238 is yes, the process 220 continues to operation 240 with the control circuitry executing the XR UI generator 204 to run additional customization filters and models on the 3D UI components (or, e.g., by executing the 3D UI element application).

In some implementations, the additional customization includes any of (i) updating or changing the 2D-3D UI matching model, (ii) changing the 3D UI elements that the model assigns for each classification group, such as with a style pack of new UI elements, (iii) running the current 3D UI elements through additional filters or ML models such as style diffusers, (iv) using a generative AI customize the current 3D UI elements based on additional themes, images, or text, (v) prioritizing controls (e.g., play/pause, previous song, and next song) over visualizations (e.g., song video, song lyrics, or album art), and (vi) displaying high priority 3D UI elements to take up more of a FOV of the XR device. In some embodiments, the priority assigned to each 3D UI element is randomized.

The process 220 continues to operation 242 with the control circuitry executing the XR UI generator 204 to generate 3D UI element groupings (or, e.g., by executing the grouping application). For example, the 3D UI elements may be assembled into groups for organizational or display purposes. In some implementations, 3D UI elements that are related (e.g., based on functionality) are grouped together. In some examples, 3D UI elements of each group are displayed close to one another, such as within a distance of a UI group threshold. In one example, rules and logic can be provided by the system to create a consistent look and feel that matches the corresponding 2D UI. The groupings are added to the 3D UI component dictionary 234. In some implementations, the 3D UI component dictionary 234 is used to enable the system to build the 3D UIs for runtime and may either be stored as part of system resources or integrated with the 2D application UI 224. Referring to FIG. 3A, 3D UI element groupings may be generated based on each of the groups 312, 314, 316, and 320.

Referring back to FIG. 2, the process 220 continues to operation 244 with the control circuitry executing the XR UI generator 204 to determine whether (i) borders to the 3D UI elements or (ii) arranging the 3D UI elements based on environmental groupings are needed (or, e.g., by executing the UI conversion application or the system interface application). The borders are formed on at least one side of the displayed 3D UI element. In some implementations, the borders form a border around the 3D UI element. In some embodiments, the borders are formed by objects in the surrounding physical environment. In some implementations, the borders are formed by objects corresponding to the geometric shapes. In some embodiments, the groupings are groups or subsets of objects in the surrounding physical environment. In some implementations, the groupings are groups or subsets of objects corresponding to the geometric shapes.

If the determination at operation 238 is yes, the process 220 continues to a borders and groupings 206 subfunction of the XR UI generator 204. The borders and groupings 206 subfunction executes operations 246-256. In some embodiments, the environmental analysis application executes any of the operations 246-256. In some embodiments, any one of the XR UI generator 204 or the borders and groupings 206 subfunction executes the environmental analysis application. In operation 246, the control circuitry executes the borders and groupings 206 subfunction to analyze captured scan information, such as discussed in relation to operation 164 of FIG. 1B. In some embodiments, the scan information includes data from sensors (e.g., sensors 108 in FIG. 1A or sensors 1013, discussed below in relation to FIG. 10). In some implementations, the scan information includes images from a camera(s). In some embodiments, operation 246 is initialized by operation 222.

Referring to FIG. 3B, the captured scan information is for a surrounding physical environment 346. The surrounding physical environment 346 is a room that includes a window, couch, organizer shelf 330, wall art 338, and end table 340. The organizer shelf 330 forms cube openings 332-336. In the embodiment depicted in FIG. 3B, objects are stored within some of the cube openings 332-336.

Referring back to FIG. 2, the process 220 continues to operation 248 with the control circuitry executing the borders and groupings 206 subfunction to capture characteristics for the geometric shapes. In some embodiments, the characteristics include any one of dimensions, inner area, border area, border width, average color of corresponding object(s) within the inner area, average color of corresponding object(s) within the border area, and color uniformity (e.g., a percentage).

Referring to FIG. 3B, characteristics are determined for geometric shapes corresponding to the organizer shelf 330, cube opening 332 labeled “X”, cube opening 336 labeled “Y”, and the wall art 338. The organizer shelf 330 has a region shape of a 4×4 square grid, area of 4 m², distance from XR device of 4 m, dominant color of white at 84%, outer border width of 0.05 m, and an outer border color of white at 100%. For example, the dominant color of white at 84% means that 84% of the pixels in the region shape of the organizer shelf 330 have a color value within a threshold of white's color threshold. The cube opening 332-X has a shape of square, area of 0.82 m², distance from XR device of 4 m, dominant color of black at 100%, outer border width of 0.03 m, and an outer border color of white at 100%. For example, the dominant color of black at 100% means that 100% of the pixels in the geometric shape corresponding to the cube opening 332-X have a color value within a threshold of black's color threshold. The cube opening 332-Y has a shape of square, area of 0.82 m², distance from XR device of 4 m, dominant color of white at 84%, outer border width of 0.03 m, and an outer border color of white at 100%. The wall art 338 has a shape of circle with 8% obscured by the organizer shelf 330, area of 0.85 m², distance from XR device of 5.6 m, dominant color of dark orange at 41%, outer border width of 0.02 m, and an outer border color of dark orange at 96%. For example, the dominant color of dark orange at 96% means that 96% of the pixels in the geometric shape corresponding to the wall art 338 have a color value within a threshold of dark orange's color threshold.

Referring back to FIG. 2, the process 220 continues to operation 250 with the control circuitry executing the borders and groupings 206 subfunction to determine whether bordered geometric shapes are detected. In some embodiments, a bordered geometric shape is any recognizable geometric shape with a border around its outer edge(s) or perimeter. In some examples, the bordered geometric shapes include framed photos, framed posters, windows having trim, and television screens having a frame or bezel. In some implementations, the borders prevent the surrounding background of area from interfering with the 3D UI. In some implementations, the entire geometric shape of each bordered geometric shape is visible (e.g., a portion of the geometric shape is not obstructed).

If the determination at operation 250 is yes, the process 220 continues to operation 252 with the control circuitry executing the borders and groupings 206 subfunction to capture characteristics of the borders of the geometric shapes. As previously discussed, the border-specific characteristics include border width and border color. In some implementations, the characteristics include whether the border forms a closed geometric shape. In some implementations, the characteristics include the number or segments (e.g., lines or arcs) that form the border.

The process 220 continues to operation 254 with the control circuitry executing the borders and groupings 206 subfunction to determine whether geometric shape groupings are detected. In some embodiments, when a grouping of geometric shapes is detected, the system identifies characteristics such as dimensions, border info (if relevant), how many bordered regions the geometric shape(s) contains, and in how the geometric shapes are arranged. In some embodiments, the system identifies groupings of geometric shapes using characteristics such as pose or orientation (e.g., objects on the same plane), adjacency, spacing, associated color, and consistency of the geometric shapes. In some embodiments, the border-specific characteristics are used to define groupings.

Referring to FIG. 3B, the control circuitry identifies a grouping of geometric shapes corresponding to cube openings 332-336 of the organizer shelf 330. In some embodiments, the grouping is identified based on the distance of the geometric shapes to one another being within the shape group threshold.

In some implementations, three subgroupings corresponding to geometric shapes of cube openings 332, 334, and 336, respectively, are identified. The three subgroupings are based on the dominant color associated with the geometric shapes. For example, the cube openings 332 have a dominant color that is light (e.g., a tint), the cube openings 334 have a dominant color that is medium (e.g., a hue or a tone), and the cube openings 336 have a dominant color that is dark (e.g., a shade). The cube openings 332 are either empty, and thus have a color of white, or contain objects within of a size or color such that the prevalent color is light. The cube openings 334 contain objects within of a size or color such that the prevalent color is medium. The cube openings 336 contain objects within that have a size and a color such that the prevalent color is dark. Colors may be classified from light to dark using any techniques known to one in the art, such as by the color's value dimension, or intensity, to name a few examples. In some embodiments, the color classifications are used to form groupings or subgrouping of the geometric shapes.

In some implementations, the control circuitry does not include the geometric shape (e.g., a circle) corresponding to the wall art 338 or the geometric shape (e.g., barrel) corresponding to the end table 340 in the groupings of the geometric shapes (e.g., squares) associated with the cube openings 332-336. In some examples, the geometric shapes corresponding to the wall art 338 and end table 340 are not included because of the differences in shape from the geometric shapes associated with the cube openings 332-336. In some examples, the geometric shapes corresponding to the wall art 338 and end table 340 are not included because the location does not match the grid-like arrangement of the geometric shapes associated with the cube openings 332-336. In some examples, the geometric shapes corresponding to the wall art 338 and end table 340 are not included because their locations are in a different plane (e.g., at a different distance from the XR device) than the geometric shapes associated with the cube openings 332-336. Referring to FIG. 2, if the determination at operation 250 is no, the process 220 continues from operation 250 to operation 254.

If the determination at operation 254 is yes, the process 220 continues from operation 254 to operation 256 with the control circuitry executing the borders and groupings 206 subfunction to capture grouping-specific characteristics of the geometric shapes. As previously discussed, the grouping-specific characteristics may include any of dimensions, pose, adjacency, spacing, associated color, and consistency of the geometric shapes. In some embodiments, the system retrieves properties of 2D UI elements from the 2D application UI 224. In some implementations, the properties include any of the number of 2D UI elements, the 2D UI element arrangement (e.g., grid, line, circular), a shape of each 2D UI element, or an icon(s) included as part of or associated with each 2D UI element. In some examples, the control circuitry uses the border and/or grouping-specific characteristics of the geometric shapes and the properties of the 2D UI elements to map the 2D UI elements to the geometric shapes in a subsequent operation.

The process 220 continues from operation 256 to operation 236 with the control circuitry executing the XR UI generator 204 to generate a new application package for a 3D UI (or, e.g., by executing the UI conversion application). In some embodiments, the 3D UI elements are mapped to geometric shapes in operation 236.

Referring to FIG. 3C, the system maps 3D UI elements of groups 313, 315, and 3D UI element 325 to the geometric shapes, based on the prevalent color and distance to one another, to create the 3D UI 311. The 3D UI elements of groups 313, 315 correspond to the 2D UI elements of groups 312 and 314. The 3D UI element 325 corresponds to weather 324 2D UI element in FIG. 2A. In some implementations, the 3D UI elements of group 315 having a prevalent light color are mapped to geometric shapes corresponding to the light and medium-colored cube openings 332 and 334. The 3D UI elements of group 313 having a prevalent dark color are mapped to the dark-colored cube openings 336 that are adjacent to one another and within 0.3 m from one another. In some implementations, darker colored 3D UI elements are mapped to light and/or medium-colored geometric shapes, such as by using the contrast ratio, to enhance contrast when the 3D UI elements are displayed over the geometric shapes. In one example depicted in FIG. 3C, a 3D UI element of group 313 having a prevalent dark color is mapped to an oval shape corresponding to the light-colored, upper surface of the end table 340. In some implementations, the 3D UI elements include only the text or icons associated with the 2D UI elements and not the corresponding background. In one example depicted in FIG. 3C, the square background of the 3D UI element of group 313 that is mapped to the end table 340 is removed and only the icon is displayed. In one example, the 3D UI element of group 313 is mapped to the end table 340 because the corresponding geometric shape is (i) at a depth that is within a depth group threshold to the depths of the geometric shapes corresponding to the dark-colored cube openings 336 and (ii) within a shape group threshold of the to the geometric shapes corresponding to the dark-colored cube openings 336.

In some embodiments, the system may prioritize geometric shapes with more desirable features, such as any of the distance from center of the surrounding physical environment of FOV, size, shape, color uniformity, border thickness, or border color uniformity. In some implementations, the prioritized geometric shapes are the first ones assigned to 3D UI elements. In some embodiments, the system retrieves historical data from the 2D application UI 224, or a user profile, to rank the 2D and/or 3D UI elements by frequency of use. In some implementations, the system prioritizes the frequently used 2D and/or 3D UI elements when mapping the 3D UI elements to the geometric shapes. In some embodiments, the system prioritizes the geometric shapes based on a distance from the XR device.

In some embodiments, the system adjusts the color of 3D UI based on color associated with the geometric shape. In one example, if only black geometric shapes are available and the 2D UI is blue, the system may increase the brightness of the corresponding 3D UI to counteract the darkening effect of the black geometric shapes.

In some embodiments, the system accounts for border-specific characteristics when mapping or grouping 3D UI elements. A geometric shape on the outer border of a region, for example a cube opening 332-336 in a corner of the organizer shelf 330, may have one or more outer borders (e.g., between the cube opening 332-336 and the organizer shelf 330) that are thicker than inner borders (e.g., between cube openings 332-336). In some implementations, the system may, depending on available space, modify the inner borders to match the outer borders. In some implementations, a similar technique may be applied if the outer border color does not match inner border color.

Referring back to FIG. 2, if the determination at operation 254 is no, the process 220 continues from operation 254 to operation 236. If the determination at operation 244 is no, the process 220 continues from operation 244 to operation 236.

In some embodiments, the mapping is performed in an operation prior to operation 236. In some implementations, the mapping is performed after either of operations 244, 254, or 256.

In some implementations, the highest priority 3D UI elements (i.e., the most used or most likely to be used) are mapped to the best geometric shapes, which may be determined based on distance to the XR device or area in a FOV, to name a few examples. In some embodiments, the mapping is performed in an operation subsequent to operation 236. In some implementations, the mapping is based on input received from a user. In some implementations, the user input is received through the XR device. In some implementations, the system uses objects in the surrounding physical environment to define 3D UI elements.

The process 220 concludes at operation 258 with the control circuitry executing the XR UI generator 204 to update a 3D UI application (e.g., associated with the 3D UI elements) on the XR device (or, e.g., by executing the UI conversion application). In some embodiments, the 2D application UI 224 is updated, such as discussed in relation to FIG. 4. In some embodiments, the I/O circuitry updates the 3D UI application.

In some embodiments, system is distributed such that the UI preprocessor 202 and XR UI generator 204 components run on a 2D application UI 224 prior to installation on the XR device. In some implementations, the components are run in their original authoring tool. In some implementations, the components are run by a separate application that handles the UI transformation of the 2D application UI 224 for a specific platform. In some examples, this provides the UI transformation and allows for additional customization by the user and/or the on-device UI customization (e.g., by running the XR UI generator 204). In one example, the updated, resulting 3D application is available for users to install through whatever mechanisms the platform provides (e.g., direct install, side loading, or a marketplace).

In some embodiments, the integration of the 2D application UI 224 and the necessary components that allow it to run with its 3D UI depends on whether XR UI generator 204 is part of the core systems of the XR device or was run as a separate tool. In some embodiments, a 3D UI renderer (e.g., 3D UI renderer 408, discussed below in relation to FIG. 4) and the translation layer are run as part of the system to handle the rendering of the new 3D UI components and translation the interactions between the 3D UI and 2D application UI 224.

In some embodiments, the XR UI generator 204 is a native application. In some implementations, the operating system of the XR device handles the 3D UI and translation layer as part of a runtime system supporting the 2D application UI 224. The 3D UI dictionary 234 is stored either as part of the system resources or connected to the 2D application UI 224. In some embodiments, the XR UI generator 204 is a container application. In some implementations, the 2D application UI 224 is wrapped in a platform-native application that contains the 2D application UI 224, the translation layer, the 3D UI renderer to display the XR content, and the 3D UI dictionary 234. In some embodiments, the XR UI generator 204 is a shell application. In some implementations, a parent application contains multiple 2D application UIs 224 and the translation layer, the 3D UI renderer, and the 3D UI dictionary 234 for each 2D application UI 224. Executing the shell application enables launching of any of the 2D application UIs 224 contained within the parent application. In some embodiments, the XR UI generator 204 is a side-by-side application. In some implementations, the 2D application UI 224 resides on the XR device. A second application contains the translation layer, 3D UI renderer, and the updated 3D UI dictionary 234. Executing the 2D application UI 224 also executes the second application, which handles the translation and rendering. In some embodiments, the XR UI generator 204 is an independent application. In some implementations, the 2D application UI 224 is modified by the system to contain and use the 3R UI dictionary 234 with updated code and metadata.

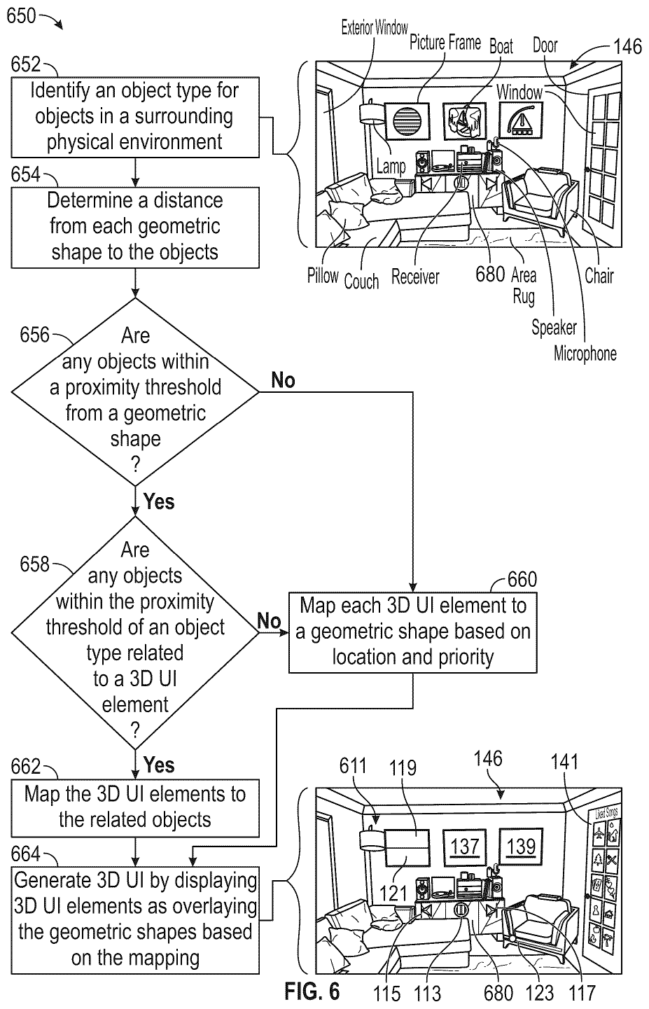

FIG. 4 is a flow chart of a detailed illustrative process 420 for modifying a 2D UI (e.g., 2D UI 110, 310 in FIGS. 1A and 3A) and corresponding 3D UI (e.g., 3D UI 111, 311 in FIGS. 1B and 3C, and 3D UI 611, 711, discussed below in relation to FIGS. 6 and 7), in accordance with embodiments of the disclosure. The 2D UI is a UI of a core 2D application 402 (or, e.g., 2D application UI 224 in FIG. 2). A system 400 (or, e.g., system 100 in FIG. 1A) performs operations of the process 420. In some implementations, the UI conversion application executes any one of operations of the process 420.

The process 420 begins at operation 422 with I/O circuitry (e.g., I/O circuitry 192 in FIG. 1A or I/O path 1002, 1112, discussed below in relation to FIGS. 10 and 11) receiving a request to run a core 2D application 402 on an XR device 412 (e.g., by executing the system interface application). The core 2D application 402 is the application underlying the 2D UI. Interactions with the 2D UI causes the core 2D application 402 to perform actions of functions. In some embodiments, the core 2D application 402 runs on the XR device 412. In some embodiments, the core 2D application 402 runs on a user device (e.g., user equipment device 1107, 1109, 1110, discussed below in relation to FIG. 11). In some embodiments, the core 2D application 402 runs on second user device or a server (e.g., server 1104, discussed below in relation to FIG. 11) remote from the XR device 412. In some embodiments, the request is received though the XR device 412. In some embodiments, the request is received through a user device.

The process 420 continues to operation 424 with control circuitry (e.g., control circuitry 190 in FIG. 1A and control circuitry 1004, 1111, discussed below in relation to FIGS. 10 and 11) of the system updating the 2D UI of the core 2D application 402. In some embodiments, the control circuitry identifies the 2D UI or an element of the 2D UI has changed or been updated. The control circuitry executes a 2D renderer 404 to update the 2D UI. In some embodiments, the update to the 2D UI reflects an input to the 2D UI, such as an interaction with a 2D UI element (e.g., 2D UI elements 112-142 (even numbers) in FIG. 1A and groups 312, 314, 316, 320 of 2D UI elements and 2D UI elements 318, 322, 324 in FIG. 3A), and the core 2D application 402 responds to the interaction. In some examples, a 2D UI element changes color, shape, of design based on the interaction. In some embodiments, the interaction triggers the core 2D application 402 to perform an action. In some embodiments, the control circuitry executes either of the UI preprocessor 202 or XR UI generator 204 discussed in relation to FIG. 2 to update the 2D UI.

The process 420 continues to operation 426 with control circuitry executing a translation layer 406 to detect changes in the 2D UI (or, e.g. the 2D analysis application). In some embodiments, the translation layer 406 detects interactions with the 2D UI elements.

The process 420 continues to operation 428 with the control circuitry executing the translation layer 406 to send updates to an 3D UI renderer 408. In some embodiments, the translation layer 406 provides the run-time translation service discussed in relation to FIG. 2. In some embodiments, the translation layer 406 maps or translates an interaction with a 2D UI element to a corresponding 3D UI element (e.g., 3D UI elements 113-143 (odd numbers) in FIG. 1B and groups 313, 315 of 3D UI elements and 3D UI element 325 in FIGS. 3B and 3C).

The process 420 continues to operation 430 with the control circuitry executing the 3D UI renderer 408 to update the 3D UI displayed in the XR device 412 (or, e.g., by executing the 3D UI element application). In some embodiments, the 3D UI renderer 408 maps or re-maps the 2D UI elements to 3D UI elements of a 3D UI dictionary 410 (or, e.g., 3D UI dictionary 234 in FIG. 2). In some embodiments, the control circuitry executes the XR UI generator 204 discussed in relation to FIG. 2 to update the 3D UI.

The process 420 continues to operation 432 with the control circuitry sending received inputs to the translation layer 406. In some embodiments, the inputs are received using the 3D UI and the XR device 412.

The process 420 continues to operation 434 with the control circuitry executing the translation layer 406 to send the received inputs to the core 2D application 402. In some embodiments, the received inputs are interactions with the 3D UI elements and the translation layer 406 detects the interactions. In some implementations, the translation layer 406 maps the interactions with the 3D UI elements to corresponding 2D UI elements. In one example, the interactions cause the core 2D application 402 to perform an action associated with a corresponding 2D UI element.

In some embodiments, the received inputs include an update to customize the 3D UI or a 3D UI element. In such embodiments, the 2D renderer 404 applies the updates the 2D UI or corresponding 2D UI element.

In some embodiments, the operations 424-434 provide bi-directional, two-way updates between the 2D UI and the 3D UI.

In some embodiments, the UI preprocessor 202 cannot analyze the compiled code of the core 2D application 402 (or, e.g., 2D application UI 224 in FIG. 2). In such embodiments, the control circuitry executes the translation layer 406 and the 3D UI renderer 408 to manage rendering of 3D UI components and translate the user interactions between the 3D UI and 2D UI. In some implementations, the core 2D application 402 is rendered offscreen (e.g., not displayed on the XR device 412) by the system. In some implementation, control circuitry executes the translation layer 406 to determine how the 3D UI element interactions affect the 2D UI of the core 2D application 402. In one example, updates to the 2D UI are passed through the translation layer 406, which determines how to render them as part of the 3D UI. The updates to the 2D UI may include any of a new 2D UI layout (e.g., different arrangement of 2D UI elements of the 2D UI), changes to the 2D UI elements (e.g., addition or removal of 2D UI elements, a change in appearance, or a change in function), or change to the underlying code of the core 2D application 402, to name a few examples.

In some embodiments, the system detects changes in geometric shapes (e.g., by executing an environmental analysis application). If such changes are detected, the system updates the inference layer and, if necessary, the XR UI. In one example, a geometric shape is associated with a window and the system detects blinds covering the window are opened. The resulting associated color of the geometric shape may no longer match the associated 3D UI element. In some implementations, the system modifies a color property (e.g., hue, saturation, or brightness) of the 3D UI element (e.g., by executing the 3D UI element application). In some implementations, the system moves the 3D UI element to a portion of the window where the blinds are not opened.

In some embodiments, the core 2D application 402 includes a runtime application, such as a web application. In some implementations, 2D UI elements of the runtime application have not been mapped to 3D UI elements. The 3D UI elements are not part of a library and have not been previously generated. The functionality (e.g., interaction paths) of the runtime 2D UI elements is not known or mapped prior to execution of the runtime application.

In some embodiments, the runtime application is executed “as-is” the first time and the system learns the 2D UI as the 2D UI elements are interacted with (e.g., by executing the 2D UI analysis application). In some embodiments, the system generates new 3D UI elements to be used as they are generated or stored for use for a subsequent execution of the runtime application (e.g., by executing the 3D UI element application). In some embodiments, the system prompts the user and receives an input indicating whether to convert the 2D UI runtime application to a 3D UI (e.g., by executing a system interface application). In some implementations, converting the 2D UI triggers the UI preprocessor 202 and/or translation layer 406 to run and the XR UI generator 204 and/or 3D UI renderer 408 launch the 3D UI version of the runtime application in the XR device 412. In some embodiments, the system stores the new 3D UI elements as part of the runtime application. In some embodiments, the system provides local storage for the new 3D UI elements or off-device storage, such as if fast download capabilities exist. In some implementations, the 3D UI elements are stored in a systematic way so that they are available to the translation layer 406 during subsequent execution of the runtime application.

In some embodiments, the system architecture for the runtime portion depends on whether the runtime application is part of the core systems of the XR device 412 or ran as a separate tool. In some embodiments, the 3D UI renderer 408 is run as part of the system to handle the rendering of the new 3D UI components.

In some embodiments, the runtime application is a native application. In some implementations, the operating system of the XR device 412 handles the XR rendering and the translation layer 406 as part of a runtime system supporting the core 2D application 402. In some embodiments, the runtime application is a container application. In some implementations, the core 2D application 402 is wrapped in a platform-native application that contains the core 2D application 402, the translation layer 406, the 3D UI renderer 408 to display the XR content, and the 3D UI elements. In some embodiments, the runtime application is a shell application. In some implementations, a parent application contains multiple core 2D applications 402 and the translation layer 406, 3D UI renderer 408, and the 3D UI elements for each core 2D application 402. Executing the shell application enables launching of any of the core 2D applications 402 contained within the parent application. In some embodiments, the runtime application is a side-by-side application. In some implementations, the core 2D application 402 resides on the XR device 412. A second application contains the translation layer 406, 3D UI renderer 408, and the 3D UI elements. Executing the core 2D application 402 also executes the second application, which handles the translation and rendering. In some embodiments, the runtime application is a language interpreter. In some implementations, the core 2D application 402 is in an interpreted language that enables processing in real time, such as when the core 2D application 402 is executed for the first time. The interpreter contains the translation layer 406 and 3D UI renderer 408 and the 3D UI elements as they are generated or updated. In some examples, the interpreter enables a determination at runtime on whether to execute the interpreter or to execute the core 2D application 402 as a native 2D UI. In one example, enabling the determination is beneficial for web applications.

In some embodiments, the runtime application is an independent application. In some implementations, the core 2D application 402 is modified to contain and use 3D UI elements during preprocessing.

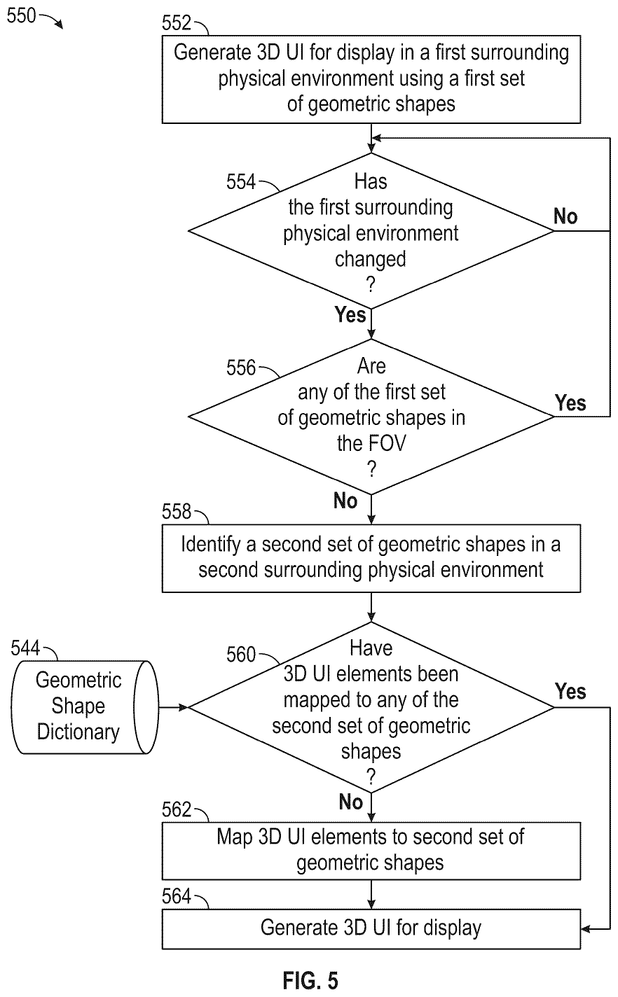

FIG. 5 is a flowchart of a detailed illustrative process 550 for updating a 3D UI (e.g., 3D UI 111, 311 in FIGS. 1B and 3C, and 3D UI 611, 711, discussed below in relation to FIGS. 6 and 7) based on the surrounding physical environment (e.g., surrounding physical environment 146, 346 in FIGS. 1B and 3B and 3C, and surrounding physical environment 746, discussed below in relation to FIG. 7), in accordance with embodiments of the disclosure. In some embodiments, a system (e.g., system 100, 400 in FIGS. 1A and 4) performs the operations of the process 550. In some embodiments, the system interface application executes the operations of the process 550.

The process 550 begins at operation 552 with control circuitry (e.g., control circuitry 190 in FIG. 1A and control circuitry 1004, 1111, discussed below in relation to FIGS. 10 and 11) of the system generating the 3D UI for display over a first surrounding physical environment using a first set of geometric shapes (e.g., geometric shapes 148 in FIG. 1B), such as described above with respect to FIGS. 1B, 2, and 3B and 3C. In some embodiments, the 3D UI is displayed using an XR device (e.g., XR device 102, 412 in FIGS. 1A and 4, and user equipment devices 1000, 1108, discussed below in relation to FIGS. 10 and 11).

The process 550 continues to operation 554 with the control circuitry determining whether the first surrounding physical environment changed (e.g., by executing an environmental analysis application). In some embodiments, the control circuitry determines the first surrounding physical environment has changed based on at least one of the first set of geometric shapes no longer being present in a FOV of the XR device. In some examples, the at least one of the first set of geometric shapes is no longer present for a time greater than an environmental time threshold. In one example, the environmental time threshold is at least 5 seconds, such as at least 10 seconds, such as at least 60 seconds. In some embodiments, the control circuitry makes the determination based on data received from sensors (e.g., sensors 108 in FIG. 1A or sensors 1013, discussed below in relation to FIG. 10) that track the geometric shapes. If the determination in operation 554 is no, the control circuitry continues to display the 3D UI and evaluate whether the first surrounding physical environment has changed.

If the determination in operation 554 is yes, the process continues to operation 556 with the control circuitry determining whether any of the first set of geometric shapes are in the FOV (e.g., by executing the environmental analysis application). If the determination in operation 556 is yes, the control circuitry continues to display the 3D UI and evaluate whether the first surrounding physical environment has changed.

In some embodiments, the control circuitry identifies geometric shapes in the FOV that are not part of the first set of geometric shapes. The geometric shapes may be present in the FOV with the first set of geometric shapes. In some implementations, the geometric shapes are identified when the FOV moves to a part of the first surrounding physical environment that was previously unseen. In some examples, the first surrounding physical environment includes a first room and the FOV moves when a previously unseen portion of the first room is present in the FOV. In some implementations, the geometric shapes are identified when the FOV moves to a second surrounding physical environment. In some examples, the FOV moves to a portion of a second room, which may be adjacent to, and beyond an entryway of, the first room. In some implementations, the control circuitry may add the geometric shapes to the first set of geometric shapes. In one example, geometric shapes in the previously unseen portion of the first room are added to the first set of geometric shapes. In some implementations, the control circuitry may ignore the geometric shapes. In one example, geometric shapes in the second room are ignored.

If the determination in operation 556 is no, the process continues to operation 558 and the control circuitry determines the surrounding physical environment has changed and identifies a second set of geometric shapes in a second surrounding physical environment.

The process 550 continues to operation 560 with the control circuitry determining whether any 3D UI elements (e.g., 3D UI elements 113-143 (odd numbers) in FIG. 1B and groups 313, 315 of 3D UI elements and 3D UI element 325 in FIGS. 3B and 3C) of the 3D UI have been mapped to the second set of geometric shapes (e.g., by executing the 3D UI element application or the mapping application). In some embodiments, characteristics of the geometric shapes may be stored in a geometric shape dictionary 544, which may be a database or library. In some embodiments, the geometric shape dictionary 544 is separate from a 2D UI dictionary (e.g., 2D UI dictionary of operation 228 in FIG. 2) and a 3D UI dictionary (e.g., 3D UI dictionary 234, 410 in FIGS. 2 and 4). In some embodiments, the geometric shape dictionary 544 is part of one of 2D UI element and 3D UI element dictionaries. In some embodiments, the geometric shape dictionary 544, the 2D UI dictionary, and the 3D UI dictionary are one database. In some embodiments, the mapping of the geometric shapes to the 3D UI elements may be stored in any of the 2D UI dictionary, 3D UI dictionary, or geometric shape dictionary 544.

If the determination in operation 560 is no, the process continues to operation 562

and the control circuitry maps the 3D UI elements to the second set of geometric shapes, such as discussed in relation to operation 170 in FIG. 1B and operation 236 in FIG. 2. In some embodiments, the mapping application executes performance of the mapping.

The process 550 continues to operation 560 with the control circuitry generates the 3D UI for display on the XR device, such as discussed in relation to operation 174 in FIG. 1B, operation 258 in FIG. 2, and operation 430 in FIG. 4. If the determination in operation 560 is yes, the process continues to operation 564 and the I/O circuitry (or, e.g., the control circuitry) generates the 3D UI for display using the existing mapping of the 3D UI elements to the second set of geometric shapes.

FIG. 6 is a schematic illustration of a process 650 for using a system (e.g., system 100, 400 in FIGS. 1A and 4) to contextually map 3D UI elements 113-143 (odd numbers), discussed in relation to FIG. 1B, to the surrounding physical environment 146, in accordance with embodiments of the disclosure. In some implementations, the UI conversion application executes any one of the operations of the process 650.

The process 650 begins at operation 652 with control circuitry (e.g., control circuitry 190 in FIG. 1A and control circuitry 1004, 1111, discussed below in relation to FIGS. 10 and 11) of the system identifying an object type for objects in a surrounding physical environment (e.g., by executing the environmental analysis application). In some embodiments, the objects include anything in the surrounding physical environment. In some examples, the objects include parts of a room, furniture, furnishings, fixtures, belongings, chattels, personal effects, natural objects, or persons. In some embodiments, the objects include items that do not have a corresponding geometric shape (e.g., geometric shapes 148 in FIG. 1B). In some embodiments, the object type includes information categorizing or describing the objects. In one example, the object type includes characteristics of the object. In the embodiment depicted in FIG. 6, the object types include area rug, chair, couch, door, door window (e.g., within a frame of the door), exterior window (e.g., in a wall), lamp, parts of an entertainment system (e.g., receiver, microphone, speaker), picture frame, boat (e.g., in artwork inside a picture frame), and pillow.

In some embodiments, the control circuitry identifies the object types based on data received from sensors (e.g., sensors 108 in FIG. 1A or e.g., sensors 1013, discussed below in relation to FIG. 10). In some embodiments, the sensor data includes images from a camera(s). In some examples, the control circuitry inputs the images into a trained ML model that classifies the objects within the images. The trained ML model may be any ML model known to one skilled in the art that classifies objects within images, such as a neural network model, such as a deep neural network, such as a convolutional neural network.

The process 650 continues to operation 654 with the control circuitry determining a distance from each geometric shape to the objects (e.g., by executing the environmental analysis application). In some implementations, the distance is a distance in 3D space. In some implementations, the distance is a distance in 2D space. In some examples, the distance is calculated from each of three geometric shapes corresponding to cabinet doors 680 of a TV stand, on which the entertainment system rests, to each of the objects. In some embodiments, the distance is calculated as described with respect to operation 164 in FIG. 1B and operations 254 and 256 in FIG. 2.

The process 650 continues to operation 656 with the control circuitry determining whether any of the objects are within a distance from each geometric shape that is less than a proximity threshold (e.g., by executing the environmental analysis application). In some implementations, the distance is an angular unit and the proximity threshold is a maximum angular unit between the geometric shape and the object. In some examples, the angular unit is a DMM, as discussed above, and the proximity threshold is 900 DMMs or less, such as 450 DMMs or less, such as 300 DMMs or less, such as −150 DMMs or less. In some implementations, the proximity threshold is a maximum number of pixels, on a display of the XR device, between the geometric shape and the object. In some implementations, the proximity threshold is a percentage of the FOV located between the between the geometric shape and the object.

In some embodiments, the control circuitry determines the object and the geometric shape are at the same location (e.g., the distance between the two is zero, within any measurement error). In some implementations, the control circuitry disregards the geometric shape at the same location with respect to operation 656.

In the embodiment depicted in FIG. 6, the distance from each geometric shape corresponding to the cabinet doors 680 to the area rug, chair, couch, microphone, receiver, and speaker are within the proximity threshold.

If the determination at operation 656 is yes, the process 650 continues to operation 658 with the control circuitry determining whether any of the objects that are within the proximity threshold are of an object type related to a 3D UI element 113-143 (odd numbers) (e.g., by executing the environmental analysis application or the 3D UI element application). In the embodiment depicted in FIG. 6, the 3D UI elements 113-143 (odd numbers) are related to an audio player, and in particular, to playing music from albums, playlists, and similar artists. The control circuitry determines that of the objects within the proximity threshold, the microphone, receiver, and speaker are of an object type that is contextually related to the 3D UI elements 113-143 (odd numbers).

If the determination at either of operations 656 or 658 are no, the process 650 continues to operation 660 with the control circuitry mapping the 3D UI elements 113-143 (odd numbers) to the geometric shapes based on location and priority (e.g., by executing the mapping application), such as described above with respect to operation 170 in FIG. 1B.

If the determination at operation 658 is yes, the process 650 continues to operation 662 with the control circuitry contextually mapping the 3D UI elements 113-143 (odd numbers) to the objects having the related object type (e.g., by executing the mapping application). In the embodiment depicted in FIG. 6, the control circuitry maps the play/pause 113, previous song 115, and next song 117 3D UI elements, which are in the high-priority group, to the three geometric shapes corresponding to the cabinet doors 680.

In some embodiments, the control circuitry performs the contextual mapping based on groups of 3D UI elements 113-143 (odd numbers) and geometric shapes. In one example, there are three 3D UI elements 113, 115, 117 and three geometric shapes. In another example, there are only two geometric shapes, and the control circuitry does not contextually map the three 3D UI elements 113, 115, 117 to the two geometric shapes. In another example, the control circuitry contextually maps two of the 3D UI elements 113-143 (odd numbers) to the two geometric shapes. In such an example, the control circuitry may not consider priority.

In some implementations, the contextual mapping considers properties of the 3D UI elements 113-143 (odd numbers) other than functionality. In some examples, the contextual mapping considers any of text, icons, shapes, colors, genres, and associations (e.g., with other applications, objects, events, or places, to name a few examples) of the 3D UI elements 113-143 (odd numbers), which may be determined by using metadata of a 2D UI (e.g., 2D UI 110, 310 in FIGS. 1A and 3A) that the 3D UI is based on. In one example, the song title 119 is “Couch Queen” and the control circuitry contextually maps the song title 119 to a geometric shape within the proximity threshold of the object having the object type of couch because of the commonality of “couch.” In another example, the control circuitry contextually maps the song lyrics 139 to a geometric shape within the proximity threshold of the object having the object type of microphone because of the association with lyrics and karaoke.

In some embodiments, only a portion of the geometric shapes are within the proximity threshold to objects having a related object type. In some implementations, the remaining portion of geometric shapes is mapped as described in operation 660.

The process 650 concludes at operation 664 with the I/O circuitry (or, e.g., the control circuitry) generating the 3D UI by displaying the 3D UI elements 113-143 (odd numbers), based on the mapping, as overlaying the geometric shapes.

FIG. 7 is an illustrative example of mapping 3D UI elements 113-143 (odd numbers), discussed in relation to FIG. 1B, of a 3D UI 711 to a virtual object, such as a mecha cockpit 782, in accordance with embodiments of the disclosure. In particular, FIG. 7 shows the 3D UI elements 113-143 (odd numbers) mapped to objects that are not in a surrounding physical environment 746.

In the embodiment depicted in FIG. 7, the 3D UI elements 113-143 (odd numbers) and the mecha cockpit 782 are displayed in the surrounding physical environment 746 using an XR device (e.g., XR device 102, 412 in FIGS. 1A and 4, and user input interface 1010, discussed below in relation to FIG. 10) of a system (e.g., system 100, 400 in FIGS. 1A and 4). Control circuitry (e.g., control circuitry 190 in FIG. 1A and control circuitry 1004, 1111, discussed below in relation to FIGS. 10 and 11) of the system identifies geometric shapes (e.g., geometric shapes 148 in FIG. 1B) on the mecha cockpit 782 (e.g., by executing the environmental analysis application) and maps the 3D UI elements 113-143 (odd numbers) to the geometric shapes (e.g., by executing the mapping application), such as discussed in relation to operations 164 and 170 in FIG. 1B, operation 236 in FIG. 2, operation 562 in FIG. 5, and operations 660 and 662 in FIG. 6. In some embodiments, the surrounding physical environment 746 is a trail through a wooded area and the mecha cockpit 782 is displayed by the XR device to a user that is walking or running on the trail to enhance the user's journey.

In the embodiment depicted in FIG. 7, the mecha cockpit 782 includes a main console and an auxiliary console left of the main console on which the 3D UI is arranged. Album art corresponding to the liked songs 141 is mapped to geometric shapes corresponding to a virtual display and a vertical line of rectangular buttons on the auxiliary console. In some examples, the top-rated favorite song is displayed in the virtual display and the remaining songs are displayed in the rectangular buttons. The main console includes left, center, and right portions. The song title 119, artist name 121, and song video 137 are mapped to geometric shapes corresponding to a display area of the left portion. A volume control 745 3D UI element is mapped to an existing scale bar on the bottom of the left portion. The song lyrics 139 3D UI element is mapped to a display area of the right portion. The shuffle play 125, cast to device 127, share song 129, and repeat song 133 3D UI elements are mapped to existing buttons on the bottom of the center portion, which are positioned above an existing profile view of the mecha. The progress bar 123 3D UI element is mapped to a geometric shape at a location just above the existing buttons. The play/pause 113, previous song 115, and next song 117 3D UI elements are mapped to a center of the center portion, just above the progress bar 123, in an area of the mecha cockpit 782 that a user is most likely to look. The 3D UI 711 also includes current speed 751 and current distance 753 3D UI elements in an upper right and left of the center portion.

In some embodiments, the 3D UI includes UI elements from multiple applications, creating a dashboard-like interface. In one example, the interface includes 3D UI elements to play a song, turn on lights, and change the temperature on the thermostat, without having to open each corresponding application independently. In some implementations, the current speed 751 and current distance 753 3D UI elements are based on a different core 2D application (e.g., 2D application UI 224, core 2D application 402 in FIGS. 2 and 4) than the 3D UI elements 113-143 (odd numbers) and 745. In one example, the control circuitry executes a translation layer (e.g., translation layer 406 in FIG. 4) to coordinate changes and interactions between the current speed 751 and current distance 753 3D UI elements and the 3D UI elements 113-143 (odd numbers) and their corresponding core 2D applications. In another example, separate translation layers are executed for each core 2D application. In some implementations, the control circuitry maps at least a portion of the 3D UI elements to geometric shapes corresponding to objects in the surrounding physical environment 746.

In some embodiments, the mecha cockpit 782 is selected from a library of database of virtual objects. In some implementations, the control circuitry identifies the mecha cockpit 782 from the database of virtual objects based on input received from a user. In some embodiments, the mecha cockpit 782 includes predetermined geometric shapes for displaying 3D UI elements. In some implementations, the mecha cockpit 782 includes a predetermined mapping to the 3D UI elements 113-143 (odd numbers). In one example, the control circuitry modifies the predetermined mapping, such as by using an input from a user.

In some embodiments, a virtual world is used instead of the surrounding physical environment 746. In some implementations, the XR device is a VR HMD and the virtual world is displayed on the VR HMD. In some implementations, the control circuitry identifies geometric shapes in the virtual world and maps 3D UI elements to the geometric shapes. In some examples, the control circuitry analyzes the view from an avatar of the user, or what the user sees in the virtual world, rather than the view captured by the sensors (e.g., sensors 108 in FIG. 1A or sensors 1013, discussed below in relation to FIG. 10) or the XR device. In some examples, the control circuitry analyzes scene data. In one example, the geometric shapes exist in locations of the virtual world outside of the mecha cockpit 782.

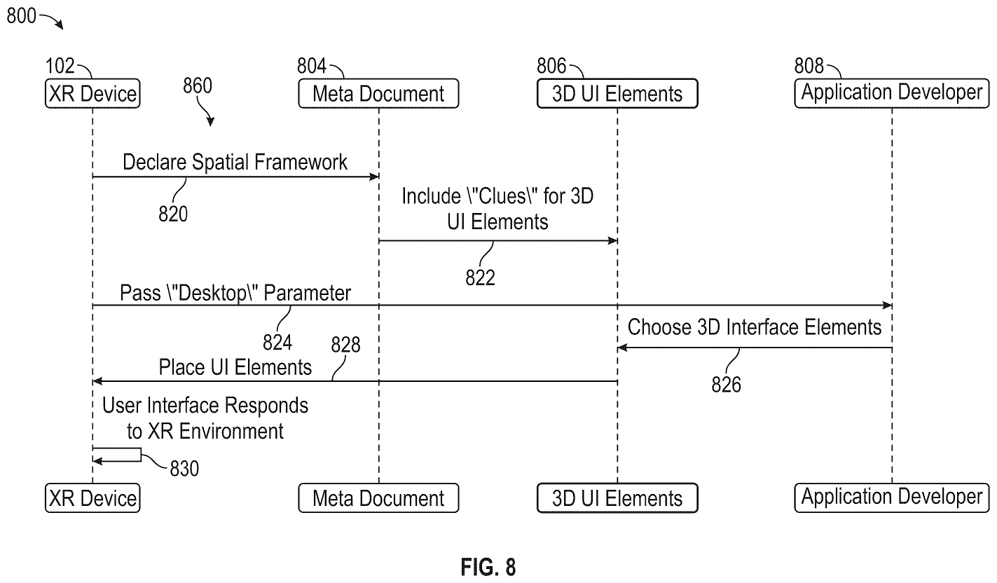

FIG. 8 illustrates an example sequence diagram 800 defining communication to coordinate between a system (e.g., system 100, 400 in FIGS. 1A and 4) for generating a 3D UI (e.g., 3D UI 111, 311, 611, 711 in FIGS. 1B, 3C, 6, and 7) and a content provider, in accordance with embodiments of the disclosure. In some embodiments, the content provider is any service that provides digitally produced content.

A process 860 depicted by the sequence diagram 800 includes a series of operations. The process 860 may be implemented, in whole or in part, by one or more systems or devices described herein. Reading from the top to the bottom of FIG. 8, in some embodiments, each operation is performed in response to the previous operation. Operations are repeated, duplicated, and/or omitted in some embodiments. Additional operations disclosed herein are included in some embodiments. Entities are shown at the top and bottom of the figure and connected by a dashed vertical line. Messages or actions between the entities are depicted as horizontal arrows with the name of the message superimposed above the arrows. The arrows are shown with end points connecting to the entities.

The entities include the XR device 102, a meta document 804, 3D UI elements 806 (or, e.g., 3D UI elements 113-143 (odd numbers) in FIG. 1B and groups 313 and 315 of 3D UI elements and 3D UI element 325 in FIGS. 3B and 3C), and an application developer 808. In some embodiments, the XR device 102 displays virtual content in an XR environment. In some implementations, the XR environment includes a surrounding physical environment (e.g., surrounding physical environment 146, 346, 746 in FIGS. 1B and 6, 3B and 3C, and 7) and the virtual content. In some implementations, the XR environment includes a virtual world, such as discussed in relation to FIG. 7, and the virtual content. In some embodiments, the meta document 804 includes HTML or another markup language. In some embodiments, application developer 808 is a web developer. In some embodiments, the content provider is the application developer 808. In some embodiments, the digitally produced content includes the 3D UI elements.

The process 860 includes the XR device 102 declaring 820 a spatial framework with pre-determined spatial aspects to the meta document 804. In some embodiments, the spatial aspects include the surrounding physical environment and the desired depth of 3D UI elements. In some embodiments, the spatial framework includes “clues” to guide the arrangement and placement of the 3D UI elements 806 under differing conditions. In some implementations, the spatial framework uses the clues are similar to framework of a responsive website where the user interface is adjusted, according to a physical device on which the website is viewed, to account for screen size, resolution, and orientation. The meta document 804 includes 822 the clues for guiding placement of the 3D UI element 806. The XR device 102 passes 824 parameters, such as plane coordinates and available space, to the application developer 808. In some implementations, the XR device 102 passes a “desktop” parameter that includes any of plane or anchor coordinates or available space (within the physical or virtual environment). In one example, the desktop parameter is passed when using the XR device 102 to view a webpage as an extension of a physical or virtual desktop. In some embodiments, the desktop parameter includes the location of geometric shapes as discussed in relation to operation 164 of FIG. 1B. In some embodiments, the desktop parameter includes at least one of the border-specific or grouping-specific characteristics of geometric shapes as discussed in relation to operations 250-256 of FIG. 2. In some embodiments, control circuitry (e.g., control circuitry 190 in FIG. 1A and control circuitry 1004, 1111, discussed below in relation to FIGS. 10 and 11) of the XR device 102 executes a translation layer (e.g., translation layer 406 in FIG. 4) to determine the clues. The application developer 808 identifies 826 the appropriate 3D UI elements 806. The 3D UI elements 806 are placed 828 in the FOV of the XR device 102 at a virtual distance from the XR device 102. In some embodiments, the operation 828 is based on any of the operations 174, 258, 430, 564, or 664 discussed in relation to FIGS. 1B, 2, 4, 5, and 6. The XR device 102 adapts 830 the 3D UI elements to changing conditions with the XR environment or to changing the XR environment. In some implementations, web or application developers determine how the 3D UI responds to the changing XR environment.

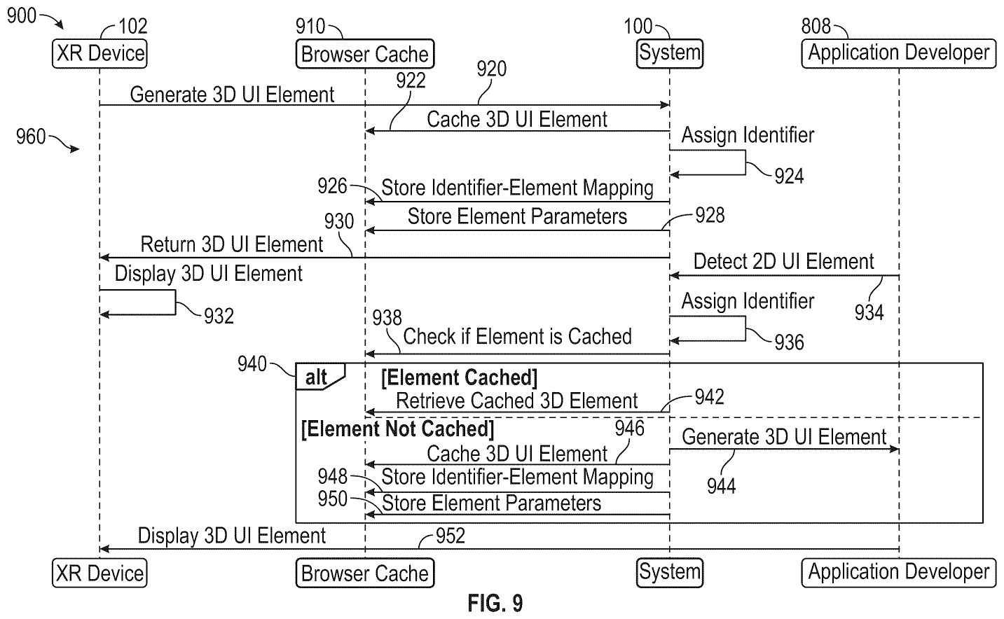

FIG. 9 illustrates an example sequence diagram 900 defining communication to coordinate between a system 100 for caching 3D UI elements (e.g., 3D UI elements 113-143 (odd numbers) in FIG. 1B and groups 313, 315 of 3D UI elements and 3D UI element 325 in FIGS. 3B and 3C) and a content provider, in accordance with embodiments of the disclosure.

The sequence diagram 900 depicts messages between entities during a process 960. The process 960 may be implemented, in whole or in part, by one or more systems or devices described herein. The entities include the XR device 102, a browser cache 910, the system 100, and the application developer 808. Boxes that are labeled “alt” are drawn around the messages of operations that may be conditional. In one example, execution of the operations in the alt boxes are based on whether a condition is satisfied. In some embodiments, the browser cache 910 is stored on a non-transitory memory (e.g., storage 1008, 1114, discussed below in relation to FIGS. 10 and 11). In some implementations, the browser cache 910 is a storage location that saves temporary data from any one of websites, applications (e.g., 2D application UI 224, core 2D application 402 in FIGS. 2 and 4, or a 3D application associated with any of 3D UI 111, 311, 611, 711 in FIGS. 1B, 3C, 6, and 7), or browsers.

The process 860 includes the XR device 102 generating 920 a 3D UI element based on a 2D UI (e.g., 2D UI 110, 310 in FIGS. 1A and 3A) and informs the system 100. In some embodiments, the 3D UI element is generated as a generic element that contains the same parameters as the 2D element. In some embodiments, the 3D UI element is generated as a complete and distinct 3D element based on the data, context, or other domain-specific generative process. In some embodiments, the operation 920 is based on any of the operations 160-162 or 230 discussed in relation to FIGS. 1A and 2. In some embodiments, control circuitry (e.g., control circuitry 190 in FIG. 1A and control circuitry 1004, 1111, discussed below in relation to FIGS. 10 and 11) of the system 100 executes an UI conversion application to perform operation 920. The system 100 caches 922 the generated 3D UI element in the browser cache 910. In some embodiments, the cached, generated 3D UI elements are re-used across multiple pages (e.g., web pages), similar 3D UI elements (e.g., on different pages), and multiple visits. In some embodiments, the 3D interface elements are cached and retrieved based on parameters such as web page or domain or application developer or publisher. For example, a generated 3D interface element for Company A may be limited to Company A websites. In some embodiments, alternative 3D UI elements are cached and linked to each other to provide immediate retrieval of the 3D UI elements when a change, such as an update to a responsive interface, is detected within the XR environment, such as discussed in relation to operation 830 in FIG. 8. In some embodiments, the browser cache is stored on a non-transitory memory (e.g., storage 1008, 1114, discussed below in relation to FIGS. 10 and 11).

The system 100 assigns 924 an identifier to the 3D UI element. In some embodiments, the identifier includes a direct mapping between a 3D UI element on a particular page, website, or application. In some embodiments, the identifier includes a broad category of 3D UI element. In some embodiments, the operation 924 is based on any of the operations 164 and 170 in FIG. 1B, operation 236 in FIG. 2, operation 562 in FIG. 5, or operations 660 and 662 in FIG. 6.

The system 100 stores 926 the mapping of the identifier to the 3D UI element in the browser cache 910. The system 100 stores 928 parameters of the 3D UI element in the browser cache 910. The system 100 returns 930 the 3D UI element to the XR device 102. In some embodiments, the sends the mapping to the XR device 102 and the XR device 102 accesses the 3D UI element from a database (e.g., 3D UI dictionary 234, 410 in FIGS. 2 and 4) based on the mapping. The XR device 102 displays 932 the 3D UI element in an XR environment (or, e.g., surrounding physical environment 146, 346, 746 in FIGS. 1B and 6, 3B and 3C, and 7). In some embodiments, the operation 932 is based on any of the operations 174, 258, 430, 564, or 664 discussed in relation to FIGS. 1B, 2, 4, 5, and 6.

The application developer 808 detects 934 a 2D UI element (e.g., 2D UI elements 112-142 (even numbers) in FIG. 1A and groups 312, 314, 316, 320 of 2D UI elements and 2D UI elements 318, 322, 324 in FIG. 3A) on a page and informs the system 100. In some embodiments, the operation 934 is based on any of the operations 154-156 or 226 discussed in relation to FIGS. 1A and 2. The system 100 assigns 936 an identifier to the 2D UI element. In some embodiments, the identifier is assigned as discussed in relation to operation 924. The system 100 checks 938 if the 3D UI element is cached in the browser cache 910. In some embodiments, control circuitry of the system 100 executes the 3D UI element application or the mapping application to perform operation 938. The operations 942-952 in alt box 940 are based on the result of operation 938. If the 3D UI element is cached, the system 100 retrieves 942 the cached 3D UI element from the browser cache 910. In some embodiments, the control circuitry of the system 100 executes a system interface application to perform operation 942. If the 3D UI element is not cached, the system 100 generates 944 a new 3D UI element for the application developer 808. The system 100 caches 946 the newly generated 3D UI element in the browser cache 910. The system 100 stores 948 the mapping of the identifier to the element in the browser cache 910. The system 100 stores 950 parameters of the 3D UI element in the browser cache 910. The application developer 808 displays 952 the 3D UI element in the XR environment.

In some implementations, the 2D UI is hosted on a domain. The domain is associated with any of a non-transitory memory (e.g., storage 1008, 1114, discussed below in relation to FIGS. 10 and 11), a server(s) (e.g., server 1104, discussed below in relation to FIG. 11), or database(s) that stores 2D UI elements and 3D UI elements (e.g., 2D UI dictionary of operation 228 in FIG. 2 and 3D UI dictionary 234, 410 in FIGS. 2 and 4) specific to the domain. The XR device 102 generates 920 the 3D UI elements. In some examples, the domain hosts several websites. In one example, the websites have subdomains. The XR device 102 re-uses previously generated 3D UI elements of the domain when loading the websites.

FIG. 10 depicts example devices and related hardware for generating a 3D UI (e.g., 3D UI 111, 311, 611, 711 in FIGS. 1B, 3C, 6, and 7) based on a 2D UI (e.g., 2D UI 110, 310 in FIGS. 1A and 3A), in accordance with some embodiments of this disclosure.

For example, user equipment device 1000 may be smart glasses, an XR device (e.g., XR device 102, 412 in FIGS. 1A and 4) such as a VR device or an AR device, a projector or hologram projector, a smartphone device, a tablet, a smart mirror, or any other suitable device capable of displaying digitally produced content, such as 3D UI elements (e.g., 3D UI elements 113-143 (odd numbers) in FIG. 1B and groups 313, 315 of 3D UI elements and 3D UI element 325 in FIGS. 3B and 3C) in a 3D environment (e.g., surrounding physical environment 146, 346, 746 in FIGS. 1B and 6, 3B and 3C, and 7) and capable of transmitting and receiving data over a communication network. In another example, user equipment device 1001 may be a user TV equipment system, smart TV, a smartphone device, a tablet, computer monitor, projector, hologram projector, or suitable device capable of generating a 3D UI for display. User equipment device 1001 may include set-top box 1015. Set-top box 1015 may be communicatively connected to microphone 1016, audio output equipment 1014 (e.g., speaker or headphones), display 1012 (e.g., display XR device 102, 412 in FIGS. 1A and 4), and sensor 1013. In some embodiments, microphone 1016 may receive audio corresponding to a voice of a user, e.g., a voice command. In some embodiments, display 1012 may be a TV display or a computer display. In some embodiments, set-top box 1015 may be communicatively connected to user input interface 1010. In some embodiments, user input interface 1010 may be a remote control device. Set-top box 1015 may include one or more circuit boards. In some embodiments, the circuit boards may include control circuitry (e.g., control circuitry 190 in FIG. 1A and control circuitry 1004, 1111, discussed below in relation to FIGS. 10 and 11), processing circuitry, and storage (e.g., RAM, ROM, hard disk, removable disk, etc.). In some embodiments, the circuit boards may include an I/O path. More specific implementations of user equipment devices are discussed below in connection with FIG. 11. In some embodiments, device 1000 may comprise any suitable number of sensors, as well as a GPS module (e.g., in communication with one or more servers and/or cell towers and/or satellites) to ascertain a location of device 1000.

Each one of user equipment device 1000 and user equipment device 1001 may receive content and data via I/O path 1002. I/O path 1002 may provide content (e.g., broadcast programming, on-demand programming, Internet content, content available over a local area network (LAN) or wide area network (WAN), and/or other content) and data to control circuitry 1004, which may comprise processing circuitry 1006 and storage 1008. Control circuitry 1004 may be used to send and receive commands, requests, and other suitable data using I/O path 1002, which may comprise I/O circuitry. I/O path 1002 may connect control circuitry 1004 (and specifically processing circuitry 1006) to one or more communications paths (described below). I/O functions may be provided by one or more of these communications paths, but are shown as a single path in FIG. 6 to avoid overcomplicating the drawing. While set-top box 1015 is shown in FIG. 6 for illustration, any suitable computing device having processing circuitry, control circuitry, and storage may be used in accordance with the present disclosure. For example, set-top box 1015 may be replaced by, or complemented by, a personal computer (e.g., a notebook, a laptop, a desktop), a smartphone, a tablet, a user-worn device (e.g., device 1000 as an XR device), a network-based server hosting a user-accessible client device, a non-user-owned device, any other suitable device, or any combination thereof.

Control circuitry 1004 may be based on any suitable control circuitry such as processing circuitry 1006. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1004 executes instructions for a UI conversion system (e.g., system 100 in FIG. 1A) stored in memory (e.g., storage 1008). Specifically, control circuitry 1004 may be instructed by the UI conversion system to perform the functions discussed above and below. The control circuitry 1004 may execute applications, such as the system interface application, UI conversion application, 2D UI analysis application, 3D UI element application, priority determination application, mapping application, grouping application, and environmental analysis application, discussed in relation to FIGS. 1-9, to perform the functions. In some implementations, processing or actions performed by control circuitry 1004 may be based on instructions received from the UI conversion system.

In client/server-based embodiments, control circuitry 1004 may include communications circuitry suitable for communicating with a server or other networks or servers. The UI conversion system may be a stand-alone application implemented on a device or a server. The UI conversion system may be implemented as software or a set of executable instructions. The instructions for performing any of the embodiments discussed herein of the UI conversion system may be encoded on non-transitory computer-readable media (e.g., a hard drive, random-access memory on a DRAM integrated circuit, read-only memory on a BLU-RAY disk, etc.). For example, in FIG. 10, the instructions may be stored in storage 1008, and executed by control circuitry 1004 of a device 1000.

In some embodiments, the UI conversion system may be a client/server application where only the client application resides on device 1000, and a server application resides on an external server (e.g., server 1104). For example, the UI conversion system may be implemented partially as a client application on control circuitry 1004 of device 1000 and partially on server 1104 as a server application running on control circuitry 1111. Server 1104 may be a part of a local area network with one or more of devices 1000 or may be part of a cloud computing environment accessed via the internet. In a cloud computing environment, several types of computing services for performing searches on the internet or informational databases, providing storage (e.g., for a database) or parsing data are provided by a collection of network-accessible computing and storage resources (e.g., server 1104), referred to as “the cloud.” Device 1000 may be a cloud client that relies on the cloud computing capabilities from server 1104 to determine whether processing should be offloaded and facilitate such offloading. When executed by control circuitry 1004 or 1111, the UI conversion system may instruct control circuitry 1004 or 1111 to perform processing tasks for the client device and facilitate a UI application session. The client application may instruct control circuitry 1004 to determine whether processing should be offloaded.

Control circuitry 1004 may include communications circuitry suitable for communicating with a server, social network service, a table or database server, or other networks or servers. The instructions for carrying out the above-mentioned functionality may be stored on a server (which is described in more detail in connection with FIG. 11). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 11). In addition, communications circuitry may include circuitry that enables peer-to-peer communication of user equipment devices, or communication of user equipment devices in locations remote from each other (described in more detail below).

Memory may be an electronic storage device provided as storage 1008 that is part of control circuitry 1004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1008 may be used to store several types of content described herein as well as UI conversion system data described above. Nonvolatile memory may also be used (e.g., to launch a boot-up routine and other instructions). Cloud-based storage may be used to supplement storage 1008 or instead of storage 1008.

Control circuitry 1004 may receive instruction from a user by way of user input interface 1010. User input interface 1010 may be any suitable user interface, such as a remote control, mouse, trackball, keypad, keyboard, touch screen, touchpad, stylus input, joystick, voice recognition interface, head tracking interface, eye tracking interface, or other user input interfaces. Display 1012 may be provided as a stand-alone device or integrated with other elements of each one of user equipment device 1000 and user equipment device 1001. For example, the display 1012 of the user equipment device 1000 may be a display screen or combiner.

The user input interface 1010 may include a head tracking interface that tracks the user equipment device 1000 movements, and correspondingly the user's field of view, in relation to the 3D environment. The user input interface 1010 may include an eye tracking interface that tracks the user's eye movements in relation to the display 1012. The display 1012 of the user equipment device 1001 may be a touchscreen or touch-sensitive display. In such circumstances, user input interface 1010 may be integrated with or combined with display 1012. In some embodiments, user input interface 1010 includes a remote-control device having one or more microphones, buttons, keypads, any other components configured to receive user input or combinations thereof. For example, user input interface 1010 may include a handheld remote-control device having an alphanumeric keypad and option buttons. In a further example, user input interface 1010 may include a handheld remote-control device having a microphone and control circuitry configured to receive and identify voice commands and transmit information to set-top box 1015.

Control circuitry 1004 may receive information from the sensor 1013 (or sensors). The information may include spatial data about nearby surroundings (e.g., surrounding physical environment 146, 346, 746 in FIGS. 1B and 6, 3B and 3C, and 7) and objects, including people. Sensor 1013 may be any suitable sensor or sensors to detect a position and orientation of the surroundings. The sensor 1013 may include transceivers, cameras, sonar, radar, lidar, lasers, global positioning system (GPS) beacons, inertial measurement systems (IMSs), accelerometers, and gyrometers. The sensor 1013 may include emitters or projectors and receivers to detect reflections of an emitted source (e.g., electromagnetic waves and soundwaves), and the control circuitry 1004 may use a delay between transmitting and receiving to determine positions and orientations of the surroundings. The sensor 1013 may perform several measurements in multiple directions. In some embodiments, the control circuitry 1004 may use the sensor 1013 to scan the surroundings and capture images of one or more objects, which may be used to determine object locations within the environment. In some embodiments, the control circuitry 1004 may generate a 3D map or scan of the surroundings, specifying locations of objects and/or locations of users in the surroundings. In some embodiments, the sensor 1013 may sense changes in its position over time, which the control circuitry 1004 may use to track the position and orientation of an object coupled to the sensor 1013. In some embodiments, the sensor 1013 is used to track a position of the user equipment device 1000, which may be used to determine the user's head and field of view. In some embodiments, a user may be requested by the control circuitry 1004 to scan his or her surroundings.

Audio output equipment 1014 may be integrated with or combined with display 1012. Display 1012 may be one or more of a monitor, a TV, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser TV, carbon nanotubes, quantum dot display, interferometric modulator display, or any other suitable equipment for displaying visual images. A video card or graphics card may generate the output to the display 1012. Audio output equipment 1014 may be provided as integrated with other elements of each one of devices 1000, 1001 or may be stand-alone units. An audio component of videos and other content displayed on display 1012 may be played through speakers (or headphones) of audio output equipment 1014. In some embodiments, audio may be distributed to a receiver (not shown), which processes and outputs the audio via speakers of audio output equipment 1014. In some embodiments, for example, control circuitry 1004 is configured to provide audio cues to a user, or other audio feedback to a user, using speakers of audio output equipment 1014. There may be a separate microphone 1016 or audio output equipment 1014 may include a microphone configured to receive audio input such as voice commands or speech. For example, a user may speak letters or words that are received by the microphone and converted to text by control circuitry 1004. In a further example, a user may voice commands that are received by a microphone and recognized by control circuitry 1004. Camera 1018 may be any suitable video camera integrated with the equipment or externally connected. Camera 1018 may be a digital camera comprising a charge-coupled device (CCD) and/or a complementary metal-oxide semiconductor (CMOS) image sensor. Camera 1018 may be an analog camera that converts to digital images via a video card. Light 1020 may be used to reflect patterns off the user's eye or to illuminate objects near the devices 1000 and 1001, and may include light emitting diode (LED) lights or other types of light producing devices. The light 1020 may be used with the camera 1018. Camera 1022 may be an IR or ultraviolet (UV) camera. Light 1024 may be an IR or UV emitter that emits light in the IR or UV wavelengths to reflect off the user's eye or nearby objects in the surrounding environment. The camera 1022 detects the reflected wavelengths. In some embodiments, the cameras 1018 and 1022 are used for eye tracking. In some embodiments, the cameras 1018 and 1022 are the same type of camera. In some embodiments, the lights 1020 and 1024 are the same type of light. In some embodiments, the cameras 1018 and 1022 are used as stereo cameras to map the surrounding environment.

The UI conversion system may be implemented using any suitable architecture. For example, it may be a stand-alone application wholly implemented on each one of user equipment device 1000 and user equipment device 1001. In such an approach, instructions of the application may be stored locally (e.g., in storage 1008), and data for use by the application is downloaded on a periodic basis (e.g., from an out-of-band feed, from an Internet resource, or using another suitable approach). Control circuitry 1004 may retrieve instructions of the application from storage 1008 and process the instructions to provide media consumption and social network interaction functionality and generate any of the displays discussed herein. Based on the processed instructions, control circuitry 1004 may determine what action to perform when input is received from user input interface 1010. For example, movement of a cursor on a display up/down may be indicated by the processed instructions when user input interface 1010 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1004 may allow a user to provide user profile information or may automatically compile user profile information. For example, control circuitry 1004 may access and monitor network data, video data, audio data, processing data, participation data from a UI conversion system and/or a social network profile. Control circuitry 1004 may obtain all or part of other user profiles that are related to a particular user (e.g., via social media networks), and/or obtain information about the user from other sources that control circuitry 1004 may access. As a result, a user can be provided with a unified experience across the user's different devices.

In some embodiments, the UI conversion system is a client/server-based application. Data for use by a thick or thin client implemented on each one of user equipment device 1000 and user equipment device 1001 may be retrieved on-demand by issuing requests to a server remote to each one of user equipment device 1000 and user equipment device 1001. For example, the remote server may store the instructions for the application in a storage device. The remote server may process the stored instructions using circuitry (e.g., control circuitry 1004) and generate the displays discussed above and below. The client device may receive the displays generated by the remote server and may display the content of the displays locally on device 1000. This way, the processing of the instructions is performed remotely by the server while the resulting displays (e.g., that may include text, a keyboard, or other visuals) are provided locally on device 1000. Device 1000 may receive inputs from the user via input interface 1010 and transmit those inputs to the remote server for processing and generating the corresponding displays. For example, device 1000 may transmit a communication to the remote server indicating that an up/down button was selected via input interface 1010. The remote server may process instructions in accordance with that input and generate a display of the application corresponding to the input (e.g., a display that moves a cursor up/down). The generated display may then be transmitted to device 1000 for presentation to the user.

In some embodiments, the I/O path 1002 may generate the output to the display 1012. In some embodiments, the I/O path 1002 may include the video generating circuitry. In some embodiments, the I/O path 1002 and the control circuitry 1004 may both generate the output to the display 1012.

In some embodiments, the UI conversion system may be downloaded and interpreted or otherwise run by an interpreter or virtual machine (run by control circuitry 1004). In some embodiments, the UI conversion system may be encoded in the ETV Binary Interchange Format (EBIF), received by control circuitry 1004 as part of a suitable feed, and interpreted by a user agent running on control circuitry 1004. For example, the UI conversion system may be an EBIF application. In some embodiments, the UI conversion system may be defined by a series of JAVA-based files that are received and run by a local virtual machine or other suitable middleware executed by control circuitry 1004. In some of such embodiments (e.g., those employing MPEG-2 or other digital media encoding schemes), the UI conversion system may be, for example, encoded and transmitted in an MPEG-2 object carousel with the MPEG audio and video packets of a program.

FIG. 11 depicts example systems, servers, and related hardware for enabling a UI conversion application to carry out the functions described herein, in accordance with some embodiments of this disclosure.

User equipment devices 1107, 1108, 1109, 1110 (e.g., e.g., XR device 102, 412 in FIGS. 1A and 4 and user equipment devices 1000, 1001 in FIG. 10) and/or other connected devices or suitable devices, or any combination thereof, may be coupled to communication network 1106. In the depicted embodiment, the user equipment device 1107 is a personal computer, user equipment device 1108 is an AR headset, user equipment device 1109 is a smartphone, and user equipment device 1110 is a TV. Communication network 1106 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1106) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 11 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth®, infrared, IEEE 702-11x, etc.), or other short-range communication via wired or wireless paths. The user equipment devices may also communicate with each other directly through an indirect path via communication network 1106.

In some embodiments, the systems comprise UI application source 1102 (e.g., 2D application UI 224, core 2D application 402 in FIGS. 2 and 4) one or more servers 1104, and one or more social network services. In some embodiments, the UI conversion system may be executed at one or more of control circuitry 1111 of server 1104 (and/or control circuitry of user equipment devices 1107, 1108, 1109, 1110). In some embodiments, spatial data about 3D environments (e.g., surrounding physical environment 146 in FIG. 1B, and surrounding physical environment 346, 746, discussed below in relation to FIGS. 3B and 3C and 7) or objects in the 3D environment, user name and preferences, information about the UI application source 1102 (e.g., present time point and time remaining), or any other suitable data structure or any combination thereof, may be stored at database 1105 maintained at or otherwise associated with server 1104, and/or at storage of one or more of user equipment devices 1107, 1108, 1109, 1110.

In some embodiments, server 1104 may include control circuitry 1111 and storage 1114 (e.g., RAM, ROM, Hard Disk, Removable Disk, etc.). Storage 1114 may store one or more databases 1105. Server 1104 may also include an I/O path 1112. I/O path 1112 may provide application UI usage data, social networking data, device information, or other data, over a local area network (LAN) or wide area network (WAN), and/or other content and data to control circuitry 1111, which may include processing circuitry, and storage 1114. Control circuitry 1111 may be used to send and receive commands, requests, and other suitable data using I/O path 1112. I/O path 1112 may connect control circuitry 1111 (and specifically control circuitry 1004) to one or more communications paths. I/O path 1112 may comprise I/O circuitry.

Control circuitry 1111 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1111 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1111 executes instructions for an emulation system application stored in memory (e.g., the storage 1114). Memory may be an electronic storage device provided as storage 1114 that is part of control circuitry 1111.

The embodiments discussed above are intended to be illustrative and not limiting. One skilled in the art would appreciate that individual aspects of the apparatus and methods discussed herein may be omitted, modified, combined, and/or rearranged without departing from the scope of the disclosure. Only the claims that follow are meant to set bounds as to what the present disclosure includes.

1. A method, comprising:
accessing a two-dimensional (2D) user interface (UI) comprising a plurality of 2D UI elements;
generating a plurality of three-dimensional (3D) UI elements of a 3D UI based on each of the plurality of 2D UI elements;
identifying a respective location of each of a plurality of geometric shapes in a surrounding physical environment of an extended reality device using at least one sensor;
determining a priority for each 3D UI element of the plurality of 3D UI elements;
mapping each 3D UI element of the plurality of 3D UI elements to a respective geometric shape of the plurality of geometric shapes based on: (a) the respective location of each of the plurality of geometric shapes in the surrounding physical environment, and (b) the respective priority for each 3D UI element of the plurality of 3D UI elements; and
generating for display, using the extended reality device, each 3D UI element to overlay the mapped respective geometric shape.

2. The method of claim 1, wherein the priority for each 3D UI element of the plurality of 3D UI elements is determined based on a frequency of interaction with the 3D UI element.

3. The method of claim 1, wherein the priority for each 3D UI element of the plurality of 3D UI elements is determined based on a spatial relationship of a respective 2D UI element to other 2D UI elements in the 2D UI.

4. The method of claim 1, wherein the priority for each 3D UI element of the plurality of 3D UI elements is determined based on a functionality the 3D UI element.

5. The method of claim 1, further comprising:
sorting each 3D UI element into one of a plurality of subsets based on a functionality of the 3D UI element; and
sorting each of the plurality of geometric shapes into one of a plurality of subsets based on the respective location, wherein:
mapping each 3D UI element to the respective geometric shape is further based on (c) the plurality of subsets of the 3D UI elements, and (d) the plurality of subsets of the geometric shapes.

6. The method of claim 1, wherein mapping each 3D UI element to a respective geometric shape further comprises:
determining an orientation of each of the plurality of geometric shapes; and
adjusting an orientation of each 3D UI element to match the orientation of the respective geometric shape.

7. The method of claim 1, further comprising:
determining a prevalent color of each of the plurality of geometric shapes; and
determining a prevalent color of each 3D UI element, wherein:
mapping each 3D UI element to the respective geometric shape is further based on a contrast ratio of the prevalent color of the 3D UI elements to the prevalent color of the geometric shapes exceeding a contrast threshold.

8. The method of claim 1, further comprising:
identifying an object type and a respective location of each of a plurality of objects in the surrounding physical environment; and
identifying a functionality of each 3D UI element, wherein:
mapping each 3D UI element to the respective geometric shape is further based on (c) the object type of each of the plurality of objects having a respective location within a proximity threshold of the respective geometric shape, and (d) the respective functionality of each 3D UI element of the plurality of 3D UI elements.

9-10. (canceled)

11. The method of claim 1, further comprising:
identifying an update to a 2D UI element of the 2D UI;
generating an updated 3D UI element of the plurality of 3D UI elements based on the updated 2D UI element; and
in response to generating the updated 3D UI element:
re-mapping each 3D UI element of the plurality of 3D UI elements to a respective geometric shape of the plurality of geometric shapes based on the respective priority for each 3D UI element of the plurality of 3D UI elements; and
generating for display, using the extended reality device, each 3D UI element to overlay the mapped respective geometric shape.

12. The method of claim 1, wherein:
accessing the 2D UI further comprises accessing a first website of a domain;
generating the plurality of 3D UI elements of the 3D UI based on each of the plurality of 2D UI elements comprises:
determining whether any of the 3D UI elements are stored in a cache of a non-transitory memory associated with the domain; and
in response to determining a portion of the 3D UI elements are stored in the cache:
retrieving the portion of the 3D UI elements stored in the cache; and
generating the remaining 3D UI elements; and
the method further comprises:
accessing a second website of the domain; and
retrieving at least one of the portion of the 3D UI elements stored in the cache.

13. A system, comprising:
at least one sensor configured to scan a surrounding physical environment;
control circuitry configured to:
access a two-dimensional (2D) user interface (UI) comprising a plurality of 2D UI elements;
generate a plurality of three-dimensional (3D) UI elements of a 3D UI based on each of the plurality of 2D UI elements;
identify a respective location of each of a plurality of geometric shapes in the surrounding physical environment of an extended reality device using the at least one sensor;
determine a priority for each 3D UI element of the plurality of 3D UI elements;
map each 3D UI element of the plurality of 3D UI elements to a respective geometric shape of the plurality of geometric shapes based on: (a) the respective location of each of the plurality of geometric shapes in the surrounding physical environment, and (b) the respective priority for each 3D UI element of the plurality of 3D UI elements; and
input/output circuitry configured to:
generate for display each 3D UI element to overlay the mapped respective geometric shape.

14. The system of claim 13, wherein the control circuitry is configured to determine the priority for each 3D UI element of the plurality of 3D UI elements based on a frequency of interaction with the 3D UI element.

15. The system of claim 13, wherein the control circuitry is configured to determine the priority for each 3D UI element of the plurality of 3D UI elements based on a spatial relationship of a respective 2D UI element to other 2D UI elements in the 2D UI.

16. The system of claim 13, wherein the control circuitry is configured to determine the priority for each 3D UI element of the plurality of 3D UI elements based on a functionality the 3D UI element.

17. The system of claim 13, wherein the control circuitry is further configured to:
sort each 3D UI element into one of a plurality of subsets based on a functionality of the 3D UI element;
sort each of the plurality of geometric shapes into one of a plurality of subsets based on the respective location; and
map each 3D UI element to the respective geometric shape based on (c) the plurality of subsets of the 3D UI elements, and (d) the plurality of subsets of the geometric shapes.

18. The system of claim 13, wherein the control circuitry is configured to map each 3D UI element to a respective geometric shape by:
determining an orientation of each of the plurality of geometric shapes; and
adjusting an orientation of each 3D UI element to match the orientation of the respective geometric shape.

19. The system of claim 13, wherein the control circuitry is configured to:
determine a prevalent color of each of the plurality of geometric shapes; and
determine a prevalent color of each 3D UI element; and
map each 3D UI element to the respective geometric shape based on a contrast ratio of the prevalent color of the 3D UI elements to the prevalent color of the geometric shapes exceeding a contrast threshold.

20. The system of claim 13, wherein the control circuitry is configured to:
identify an object type and a respective location of each of a plurality of objects in the surrounding physical environment;
identify a functionality of each 3D UI element; and
map each 3D UI element to the respective geometric shape based on (c) the object type of each of the plurality of objects having a respective location within a proximity threshold of the respective geometric shape, and (d) the respective functionality of each 3D UI element of the plurality of 3D UI elements.

21-22. (canceled)

23. The system of claim 13, wherein:
the control circuitry is further configured to:
identify an update to a 2D UI element of the 2D UI;
generate an updated 3D UI element of the plurality of 3D UI elements based on the updated 2D UI element; and
in response to generating the updated 3D UI element, re-map each 3D UI element of the plurality of 3D UI elements to a respective geometric shape of the plurality of geometric shapes based on the respective priority for each 3D UI element of the plurality of 3D UI elements; and
the input/output circuitry is further configured to:
in response to the control circuitry generating the updated 3D UI element, generate for display each 3D UI element to overlay the mapped respective geometric shape.

24. The system of claim 13, wherein the control circuitry is configured to:
access the 2D UI by accessing a first website of a domain;
generate the plurality of 3D UI elements of the 3D UI based on each of the plurality of 2D UI elements by:
determining whether any of the 3D UI elements are stored in a cache of a non-transitory memory associated with the domain; and
in response to determining a portion of the 3D UI elements are stored in the cache:
retrieving the portion of the 3D UI elements stored in the cache; and
generating the remaining 3D UI elements;
access a second website of the domain; and
retrieve at least one of the portion of the 3D UI elements stored in the cache.

25-60. (canceled)
